(19) United States
(12) Patent Application Publication
(10) Pub. No.: US 2024/0265637 A1
(43) Pub. Date: Aug. 8, 2024

(54) APPARATUSES, SYSTEMS, AND INTERFACES FOR A 360 ENVIRONMENT INCLUDING OVERLAID PANELS AND HOT SPOTS AND METHODS FOR IMPLEMENTING AND USING SAME

(71) Applicant: Quantum Interface, LLC, Austin, TX (US)

(72) Inventor: Jonathan Josephson, Austin, TX (US)

(73) Assignee: Quantum Interface, LLC, Austin, TX (US)

(21) Appl. No.: 18/220,097

(22) Filed: Jul. 10, 2023

Related U.S. Application Data
(60) Provisional application No. 63/359,606, filed on Jul. 8, 2022.

(51) Int. Cl. G06T 19/00; H04N 13/351; H04N 21/2187; H04N 23/698

(52) U.S. Cl. CPC G06T 19/00; H04N 13/351; H04N 21/2187; H04N 23/698

(57) ABSTRACT

Apparatuses, systems, and interfaces and methods implementing them for creating. interacting, modifying, and updating 360 environments, the environments including a 360 display output overlaid with selectable and modifiable live feed panels and selectable and modifiable informational hot spots.

### RELATED APPLICATIONS

This application claims the benefit of and priority to U.S. Provisional Patent Application Ser. No. 63/359,606 filed Jul. 8, 2022 (8 Jul. 2022).

United States Patent Published Application Nos. 20170139556 published May 18, 2017, 20190391729 published Dec. 26, 2019, WO2018237172 published Dec. 27, 2018, WO2021021328 published Feb. 4, 2021, and U.S. Pat. No. 7,831,932 issued Nov. 9, 2010, U.S. Pat. No. 7,861,188 issued Dec. 28, 2010, U.S. Pat. No. 8,788,966 issued Jul. 22, 2014, U.S. Pat. No. 9,746,935 issued Aug. 29, 2017, U.S. Pat. No. 9,703,388 issued Jul. 11, 2017, U.S. Pat. No. 11,256,337 issued Feb. 22, 2022, U.S. Pat. No. 10,289,204 issued May 14, 2019, U.S. Pat. No. 10,503,359 issued Dec. 10, 2019, U.S. Pat. No. 10,901,578 issued Jan. 26, 2021, U.S. Pat. No. 11,221,739 issued Jan. 11, 2022, U.S. Pat. No. 10,263,967 issued Apr. 16, 2019, U.S. Pat. No. 10,628,977 issued Apr. 21, 2020, U.S. Pat. No. 11,205,075 issued Dec. 21, 2021, U.S. Pat. No. 10,788,948 issued Sep. 29, 2020, and U.S. Pat. No. 11,226,714 issued Jan. 18, 2022, are incorporated by reference via the application of the Closing Paragraph.

### BACKGROUND OF THE DISCLOSURE

### 1. Field of the Disclosure

Embodiments of the present disclosure relate to apparatuses and/or systems and interfaces and/or methods implementing them, wherein the apparatuses and/or systems are configured to capture an image sequence from a 360-image acquisition subsystem located at a facility and to create, interact, modify, and update 360 environments derived from the captured image sequence.

In particular, embodiments of the present disclosure relate to apparatuses and/or systems and interfaces and/or methods implementing them, wherein the apparatuses and/or systems comprising an electronic device including one or more processing units, one or more memory units, one or more storage devices, one or more input devices, one or more output devices, an operating system or structure, software and configuration-based protocols and/or elements, communication software and hardware, and routines for implementing the systems/apparatuses, wherein the systems/apparatuses are configured to capture an image sequence from a 360-image acquisition subsystem located at a facility and to create, interact, modify, and update 360 environments derived from the captured image sequence. The environments include a 360 display output overlaid with selectable and modifiable live feed panels and selectable and modifiable informational hot spots, wherein one or more 360 cameras mounted in a site or location produces one or more continuous 360 outputs of the site or location. The site or location includes a number of visual output or display devices, each of the visual output or display devices include a panel overlaid on the device and linked to that device output, wherein the panels or hot spots may be activated, selected, altered, modified, and/or manipulated using hard selection protocols, motion based protocols without hard selection protocols, or any combination thereof.

### 2. Description of the Related Art

While there are numerous 360 degree methodologies, there is still a need in the art for improved systems and methods for creating, interacting, modifying, and updating 360 environments, the environments including a 360 display output overlaid with selectable and modifiable live feed panels and selectable and modifiable informational hot spots.

### SUMMARY OF THE DISCLOSURE

Embodiments of this disclosure provide apparatuses comprising an electronic device including one or more processing units, one or more memory units, one or more storage devices, one or more input devices, one or more output devices, an operating system or structure, software and configuration-based protocols and/or elements, communication software and hardware, and routines for implementing the apparatuses. The apparatuses are configured to capture an image sequence from a 360-image acquisition subsystem located at a facility. The apparatuses are also configured to create, interact, modify, and update an environment derived from the captured image sequence. The facilities may include, without limitation, commercial facilities including wholesale facilities, retail facilities, manufacturing facilities, mining facilities, oil and/or gas refining facilities, chemical production facilities, recycling facilities, or any other commercial facility; residential facilities including apartment complexes, planned residential communities, etc.; governmental facilities; military facilities; medical facilities including hospital facilities, medical clinic facilities, nursing facilities, senior facilities, or any other medical facility; institutions of higher education including universities, colleges, community colleges, vocational training institutions, or any other educational facility; or any other facility amenable to be imaged using a 360-image acquisition subsystem. The 360 image acquisition subsystem may include a single 360 camera, a plurality of 360 cameras, or a mixture of 360 cameras and directional cameras, i.e., cameras designed to capture images within the viewing field of the directional cameras. The environments may be overlaid over the physical facility being imaged. The environments may be populated with selectable live feed viewing windows or panels, selectable group objects, and selectable and modifiable informational hot spot objects. The image sequence may be continuous (real time or near real time), semi-continuous (continuous image sequences separated by blank periods), intermittent (image sequences captured on a schedule), or on command (sequences captured when prompted by a user).

Embodiments of this disclosure provide systems comprising an electronic device including one or more processing units, one or more memory units, one or more storage devices, one or more input devices, one or more output devices, an operating system or structure, software and configuration-based protocols and/or elements, communication software and hardware, and routines for implementing the apparatuses. The systems are configured to capture an image sequence from a 360-image acquisition subsystem located at a facility. The systems are also configured to create, interact, modify, and update an environment derived from the captured image sequence. The facilities may include, without limitation, commercial facilities including wholesale facilities, retail facilities, manufacturing facilities, mining facilities, oil and/or gas refining facilities, chemical production facilities, recycling facilities, or any other commercial facility; residential facilities including apartment complexes, planned residential communities, etc.; governmental facilities; military facilities; medical facilities including hospital facilities, medical clinic facilities, nursing facilities, senior facilities, or any other medical facility; institutions of higher education including universities, colleges, community colleges, vocational training institutions, or any other educational facility; or any other facility amenable to be imaged using a 360-image acquisition subsystem. The 360 image acquisition subsystem may include a single 360 camera, a plurality of 360 cameras, or a mixture of 360 cameras and directional cameras, i.e., cameras designed to capture images within the viewing field of the directional cameras. The environments may be overlaid over the physical facility being imaged. The environments may be populated with selectable live feed viewing windows or panels, selectable group objects, and selectable and modifiable informational hot spot objects. The image sequence may be continuous (real time or near real time), semi-continuous (continuous image sequences separated by blank periods), intermittent (image sequences captured on a schedule), or on command (sequences captured when prompted by a user).

Embodiments of this disclosure provide interfaces implementing apparatuses/systems for creating, interacting, modifying, and updating an environment derived from the captured image sequence. The interfaces are implemented on an electronic device including one or more processing units, one or more memory units, one or more storage devices, one or more input devices, one or more output devices, an operating system or structure, software and configuration-based protocols and/or elements, communication software and hardware, and routines for implementing the apparatuses. The interfaces are configured to capture an image sequence from a 360-image acquisition subsystem located at a facility. The interfaces are also configured to create, interact, modify, and update an environment derived from the captured image sequence. The facilities may include, without limitation, commercial facilities including wholesale facilities, retail facilities, manufacturing facilities, mining facilities, oil and/or gas refining facilities, chemical production facilities, recycling facilities, or any other commercial facility; residential facilities including apartment complexes, planned residential communities, etc.; governmental facilities; military facilities; medical facilities including hospital facilities, medical clinic facilities, nursing facilities, senior facilities, or any other medical facility; institutions of higher education including universities, colleges, community colleges, vocational training institutions, or any other educational facility; or any other facility amenable to be imaged using a 360-image acquisition subsystem. The 360 image acquisition subsystem may include a single 360 camera, a plurality of 360 cameras, or a mixture of 360 cameras and directional cameras, i.e., cameras designed to capture images within the viewing field of the directional cameras. The environments may be overlaid over the physical facility being imaged. The environments may be populated with selectable live feed viewing windows or panels, selectable group objects, and selectable and modifiable informational hot spot objects. The image sequence may be continuous (real time or near real time), semi-continuous (continuous image sequences separated by blank periods), intermittent (image sequences captured on a schedule), or on command (sequences captured when prompted by a user).

Embodiments of this disclosure provide methods for implementing apparatuses/systems for creating, interacting, modifying, and updating an environment derived from the captured image sequence. The methods are implemented on an electronic device including one or more processing units, one or more memory units, one or more storage devices, one or more input devices, one or more output devices, an operating system or structure, software and configuration-based protocols and/or elements, communication software and hardware, and routines for implementing the apparatuses. The methods comprise capturing an image sequence from a 360-image acquisition subsystem located at a facility. The methods comprise creating, interacting, modifying, and updating an environment derived from the captured image sequence. The facilities may include, without limitation, commercial facilities including wholesale facilities, retail facilities, manufacturing facilities, mining facilities, oil and/or gas refining facilities, chemical production facilities, recycling facilities, or any other commercial facility; residential facilities including apartment complexes, planned residential communities, etc.; governmental facilities; military facilities; medical facilities including hospital facilities, medical clinic facilities, nursing facilities, senior facilities, or any other medical facility; institutions of higher education including universities, colleges, community colleges, vocational training institutions, or any other educational facility; or any other facility amenable to be imaged using a 360-image acquisition subsystem. The 360 image acquisition subsystem may include a single 360 camera, a plurality of 360 cameras, or a mixture of 360 cameras and directional cameras, i.e., cameras designed to capture images within the viewing field of the directional cameras. The environments may be overlaid over the physical facility being imaged. The environments may be populated with selectable live feed viewing windows or panels, selectable group objects, and selectable and modifiable informational hot spot objects. The image sequence may be continuous (real time or near real time), semi-continuous (continuous image sequences separated by blank periods), intermittent (image sequences captured on a schedule), or on command (sequences captured when prompted by a user).

### BRIEF DESCRIPTION OF THE DRAWINGS OF THE DISCLOSURE

The disclosure may be better understood with reference to the following detailed description together with the appended illustrative drawings in which like elements are numbered the same:

FIG. 1A depicts an embodiment of a 360 apparatus or system comprising a room including a plurality of workstations arranged in a matrix format, each of the workstations includes a computer having a display device, e.g., a CRT, a touch screen, or any other display device, one or more a user input devices, e.g., keyboard devices, audio input devices, eye tracking devices, head tracking devices, mouse devices, joy stick devices, touch pad devices, surface of touchscreen devices, or any other user input devices, one or more user output devices, e.g., speakers, tactile output devices, and any other user input device, and a 360 camera subsystem.

FIG. 1B depicts an embodiment of a computer controllable display derived from the 360 camera subsystem of the 360 apparatus or system including a plurality of activatable workstation overlays, a plurality of informational hot stops, and a plurality of group workstation selection objects.

FIGS. 1C-F depict an embodiment of a motion-based selection illustrating the selection of a particular workstation based on motion-based processing.

FIGS. 1G-I depict an embodiment of a motion-based selection illustrating the selection of a particular workstation group object based on motion-based processing.

FIG. 2A depicts an embodiment of a 360 apparatus or system comprising a room including a plurality of workstations including a computer having a display device, a keyboard device or text entry device, and a mouse or user input device, and a 360 camera subsystem.

FIG. 2B depicts an embodiment of a computer controllable display derived from the 360 camera subsystem of the 360 apparatus or system including a plurality of activatable workstation overlays, a plurality of informational hot stops, and a plurality of group workstation selection objects.

FIGS. 2C-F depict an embodiment of a motion-based selection illustrating the selection of a particular workstation based on motion-based processing.

FIG. 3A depicts an embodiment of a 360 apparatus or system comprising a room including a plurality of workstations including a computer having a display device, a keyboard device or text entry device, and a mouse or user input device, and a 360 camera subsystem.

FIG. 3B depicts an embodiment of a computer controllable display derived from the 360 camera subsystem of the 360 apparatus or system including a plurality of activatable workstation overlays, a plurality of informational hot stops, and a plurality of group workstation selection objects.

FIGS. 3C-E depict an embodiment of a motion-based selection illustrating the selection of a particular workstation based on motion-based processing.

FIGS. 3F-H depict an embodiment of a motion-based selection illustrating the selection of a particular workstation group object based on motion-based processing.

### DEFINITIONS USED IN THE DISCLOSURE

The term “at least one”, “one or more”, and “one or a plurality” mean one thing or more than one thing with no limit on the exact number; these three terms may be used interchangeably within this application. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “hard select” or “hard select protocol” or “hard selection” or “hard selection protocol” means a mouse click or double click (right and/or left), keyboard key strike, tough down event, lift off event, touch screen tab, haptic device touch, voice command, hover event, eye gaze event, or any other action that required a user action to generate a specific output to affect a selection of an object or item displayed on a display device. The term “voice command” means an audio command sensed by an audio sensor. The term “neural command” means a command sensed by a sensor capable of reading neuro states.

The term “motion” and “movement” are often used interchangeably and mean motion or movement that is capable of being detected by a motion sensor within an active zone of the sensor, wherein the motion may have properties including direction, speed, velocity, acceleration, magnitude of acceleration, and/or changes of any of these properties over a period of time. Thus, if the sensor is a forward viewing sensor and is capable of sensing motion within a forward extending conical active zone, then movement of anything within that active zone that meets certain threshold detection criteria, will result in a motion sensor output, where the output may include at least direction, angle, distance/displacement, duration (time), velocity, and/or acceleration. Moreover, if the sensor is a touch screen or multitouch screen sensor and is capable of sensing motion on its sensing surface, then movement of anything on that active zone that meets certain threshold detection criteria, will result in a motion sensor output, where the output may include at least direction, angle, distance/displacement, duration (time), velocity, and/or acceleration. Of course, the sensors do not need to have threshold detection criteria, but may simply generate output anytime motion or any kind is detected. The processing units can then determine whether the motion is an actionable motion or movement and a non-actionable motion or movement.

The term “physical sensor” means any sensor capable of sensing any physical property such as temperature, pressure, humidity, weight, geometrical properties, meteorological properties, astronomical properties, atmospheric properties, light properties, color properties, chemical properties, atomic properties, subatomic particle properties, or any other physical measurable property.

The term “motion sensor” or “motion sensing component” means any sensor or component capable of sensing motion of any kind by anything with an active zone—area or volume, regardless of whether the sensor's or component's primary function is motion sensing. Of course, the same is true of sensor arrays regardless of the types of sensors in the arrays or for any combination of sensors and sensor arrays.

The term “biometric sensor” or “biometric sensing component” means any sensor or component capable of acquiring biometric data.

The term “bio-kinetic sensor” or “bio-kinetic sensing component” means any sensor or component capable of simultaneously or sequentially acquiring biometric data and kinetic data (i.e., sensed motion of any kind) by anything moving within an active zone of a motion sensor, sensors, array, and/or arrays—area or volume, regardless of whether the primary function of the sensor or component is motion sensing.

The term “real items” or “real world items” means any real world object such as humans, animals, plants, devices, articles, robots, drones, environments, physical devices, mechanical devices, electro-mechanical devices, magnetic devices, electro-magnetic devices, electrical devices, electronic devices or any other real world device, etc. that are capable of being controlled or observed by a monitoring subsystem and collected and analyzed by a processing subsystem.

The term “virtual item” means any computer generated (GC) items or any feature, element, portion, or part thereof capable of being controlled by a processing unit. Virtual items include items that have no real world presence, but are still controllable by a processing unit, or may include virtual representations of real world items. These items include elements within a software system, product or program such as icons, list elements, menu elements, generated graphic objects, 2D and 3D graphic images or objects, generated real world objects such as generated people, generated animals, generated devices, generated plants, generated landscapes and landscape objects, generate seascapes and seascape objects, generated skyscapes or skyscape objects, or any other generated real world or imaginary objects. Haptic, audible, and other attributes may be associated with these virtual objects in order to make them more like “real world” objects.

The term “gaze controls” means taking gaze tracking input from sensors and converting the output into control features including all type of commands. The sensors may be eye and/or head tracking sensors, where the sensor may be processors that are in communication with mobile or non-mobile apparatuses including processors. In VR/AR/MR/XR applications using mobile or non-mobile devices, the apparatuses, systems, and interfaces of this disclosure may be controlled by input from gaze tracking sensors, from processing gaze information from sensors on the mobile devices or non-mobile devices or communication with the mobile devices or non-mobile devices that are capable of determine gaze and/or posture information, or mixtures and combinations.

The term “eye tracking sensor” means any sensor capable of tracking eye movement such as eye tracking glasses, eye tracking cameras, or any other eye tracking sensor.

The term “head tracking sensor” means any sensor capable of tracking head movement such as head tracking helmets, eye tracking glasses, head tracking cameras, or any other head tracking sensor.

The term “face tracking sensor” means any sensor capable of tracking face movement such as any facial head tracking gear, face tracking cameras, or any other face tracking sensor.

The term “gaze” or “pose” or “pause” means any type of fixed motion over a period of time that may be used to cause an action to occur. Thus, in eye tracking, a gaze is a fixed stare of the eyes or eye over a period of time greater than a threshold, in body, body part, or face tracking, a pose is a stop in movement of the body or body part or holding a specific body posture or body part configuration for a period of time greater than a threshold, and a pause is a stop in motion for a period of time greater than a threshold, that may be used by the systems, apparatuses, interfaces, and/or implementing methods to cause an action to occur.

The term “real object” or “real world object” means real world device, attribute, or article that is capable of being controlled by a processing unit. Real objects include objects or articles that have real world presence including physical, mechanical, electro-mechanical, magnetic, electro-magnetic, electrical, or electronic devices, waveform devices, or any other real world device that may be controlled by a processing unit.

The term “virtual object” means any construct generated in or attribute associated with a virtual world or by a computer and may be displayed by a display device and that are capable of being controlled by a processing unit. Virtual objects include objects that have no real world presence, but are still controllable by a processing unit or output from a processing unit(s). These objects include elements within a software system, product or program such as icons, list elements, menu elements, applications, files, folders, archives, generated graphic objects, 1D, 2D, 3D, and/or nD graphic images or objects, generated real world objects such as generated people, generated animals, generated devices, generated plants, generated landscapes and landscape objects, generate seascapes and seascape objects, generated sky scapes or sky scape objects, 1D, 2D, 3D, and/or nD zones, 2D, 3D, and/or nD areas, 1D, 2D, 3D, and/or nD groups of zones, 2D, 3D, and/or nD groups or areas, volumes, attributes or characteristics such as quantity, shape, zonal, field, affecting influence changes or the like, or any other generated real world or imaginary objects or attributes. Augmented and/or Mixed reality is a combination of real and virtual objects and attributes.

The term “entity” means a human or an animal or robot or robotic system (autonomous or non-autonomous or virtual representation of a real or imaginary entity.

The term “entity object” means a human or a part of a human (fingers, hands, toes, feet, arms, legs, eyes, head, body, etc.), an animal or a part of an animal (fingers, hands, toes, feet, arms, legs, eyes, head, body, etc.), or a real world object under the control of a human or an animal or a robot and include such articles as pointers, sticks, or any other real world object that can be directly or indirectly controlled by a human or animal or a robot. In VR/AR environments, the entity object may also include virtual objects.

The term “mixtures” means different objects, attributes, data, data types or any other feature that may be mixed together or controlled together.

The term “combinations” means different objects, attributes, data, data types or any other feature that may be packages or bundled together but remain separate.

The term “sensor data” means data derived from at least one sensor including user data, motion data, environment data, temporal data, contextual data, historical data, waveform data, other types of data, and/or mixtures and combinations thereof.

The term “user data” means user attributes, attributes of entities under the control of the user, attributes of members under the control of the user, information or contextual information associated with the user, or mixtures and combinations thereof.

The terms “user features”, “entity features”, and “member features” means features including: (a) overall user, entity, or member shape, texture, proportions, information, matter, energy, state, layer, size, surface, zone, area, any other overall feature, attribute or characteristic, and/or mixtures or combinations thereof; (b) specific user, entity, or member part shape, texture, proportions, characteristics, any other part feature, and/or mixtures or combinations thereof; (c) particular user, entity, or member dynamic shape, texture, proportions, characteristics, any other part feature, and/or mixtures or combinations thereof; and (d) mixtures or combinations thereof. For certain software programs, routines, and/or elements, features may represent the manner in which the program, routine, and/or element interact with other software programs, routines, and/or elements operate or are controlled. All such features may be controlled, manipulated, and/or adjusted by the motion-based systems, apparatuses, and/or interfaces of this disclosure.

The term “motion data” or “movement data” means data generated by one or more motion sensor or one or more sensors of any type capable of sensing motion/movement comprising one or a plurality of motions/movements detectable by the motion sensors or sensing devices.

The term “motion properties” or “movement properties” means properties associated with the motion data including motion/movement direction (linear, curvilinear, circular, elliptical, etc.), motion/movement distance/displacement, motion/movement duration (time), motion/movement velocity (linear, angular, etc.), motion/movement acceleration (linear, angular, etc.), motion signature or profile—manner of motion/movement (motion/movement properties associated with the user, users, objects, areas, zones, or combinations of thereof), dynamic motion properties such as motion in a given situation, motion learned by the system based on user interaction with the systems, motion characteristics based on the dynamics of the environment, influences or affectations, changes in any of these attributes, and/or mixtures or combinations thereof. Motion or movement based data is not restricted to the movement of a single body, body part, and/or member under the control of an entity, but may include movement of one or any combination of movements of any entity and/or entity object. Additionally, the actual body, body part and/or member's identity is also considered a movement attribute. Thus, the systems/apparatuses, and/or interfaces of this disclosure may use the identity of the body, body part and/or member to select between different set of objects that have been pre-defined or determined based on environment, context, and/or temporal data.

The term “gesture” or“predetermine movement pattern” means a predefined movement or posture preformed in a particular manner such as closing a fist lifting a finger that is captured compared to a set of predefined movements that are tied via a lookup table to a single function and if and only if, the movement is one of the predefined movements does a gesture based system actually go to the lookup and invoke the predefined function.

The term “environment data” means data associated with the user's surrounding or environment such as location (GPS, etc.), type of location (home, office, store, highway, road, etc.), extent of the location, context, frequency of use or reference, attributes, characteristics, and/or mixtures or combinations thereof.

The term “temporal data” means data associated with duration of motion/movement, events, actions, interactions, etc., time of day, day of month, month of year, any other temporal data, and/or mixtures or combinations thereof.

The term “historical data” means data associated with past events and characteristics of the user, the objects, the environment and the context gathered or collected by the systems over time, or any combinations of these.

The term “contextual data” means data associated with user activities, environment activities, environmental states, frequency of use or association, orientation of objects, devices or users, association with other devices and systems, temporal activities, any other content or contextual data, and/or mixtures or combinations thereof.

The term “predictive data” means any data from any source that permits that apparatuses, systems, interfaces, and/or implementing methods to use data to modify, alter, change, augment, update, enhance, reformat, restructure, and/or redesign a virtual training routine, exercise, program, etc. to better tailor the training routine, exercise, program, etc. for each user or for all users, where the changes may be implemented before, during and after a training session.

The term “simultaneous” or “simultaneously” means that an action occurs either at the same time or within a small period of time. Thus, a sequence of events are considered to be simultaneous if they occur concurrently or at the same time or occur in rapid succession over a short period of time, where the short period of time ranges from about 1 nanosecond to 5 second. In other embodiments, the period ranges from about 1 nanosecond to 1 second. In other embodiments, the period ranges from about 1 nanosecond to 0.5 seconds. In other embodiments, the period ranges from about 1 nanosecond to 0.1 seconds. In other embodiments, the period ranges from about 1 nanosecond to 1 millisecond. In other embodiments, the period ranges from about 1 nanosecond to 1 microsecond. It should be recognized that any value of time between any stated range is also covered.

The term “and/or” means mixtures or combinations thereof so that whether an “and/or” connectors is used, the “and/or” in the phrase or clause or sentence may end with “and mixtures or combinations thereof”.

The term “spaced apart” means for example that objects displayed in a window of a display device are separated one from another in a manner that improves an ability for the systems, apparatuses, and/or interfaces to discriminate between objects based on movement sensed by motion sensors associated with the systems, apparatuses, and/or interfaces.

The term “maximally spaced apart” means that objects displayed in a window of a display device are separated one from another in a manner that maximizes a separation between the objects to improve an ability for the systems, apparatuses, and/or interfaces to discriminate between objects based on motion/movement sensed by motion sensors associated with the systems, apparatuses, and/or interfaces.

The term “s” means one or more seconds. The term “ms” means one or more milliseconds (10⁻³ seconds). The terms “us” means one or more micro seconds (10⁻⁶ seconds). The term “ns” means nanosecond (10⁻⁹ seconds). The term “ps” means pico second (10⁻¹² seconds). The term “fs” means femto second (10⁻¹⁵ seconds). The term “as” means femto second (10⁻¹⁸ seconds).

The term “hold” means to remain stationary at a display location for a finite duration generally between about 1 ms to about 2 s.

The term “brief hold” means to remain stationary at a display location for a finite duration generally between about 1 μs to about 1 s.

The term “microhold” or “micro duration hold” means to remain stationary at a display location for a finite duration generally between about 1 as to about 500 ms. In certain embodiments, the microhold is between about 1 fs to about 500 ms. In certain embodiments, the microhold is between about 1 ps to about 500 ms. In certain embodiments, the microhold is between about 1 ns to about 500 ms. In certain embodiments, the microhold is between about 1 μs to about 500 ms. In certain embodiments, the microhold is between about 1 ms to about 500 ms. In certain embodiments, the microhold is between about 100 μs to about 500 ms. In certain embodiments, the microhold is between about 10 ms to about 500 ms. In certain embodiments, the microhold is between about 10 ms to about 250 ms. In certain embodiments, the microhold is between about 10 ms to about 100 ms.

The term “VR” means virtual reality and encompasses computer-generated simulations of a two-dimension, three-dimensional and or four-dimensional, or multi-dimensional images and/or environments that may be interacted with in a seemingly real or physical way by a person using special electronic equipment, such as a helmet with a screen inside or gloves fitted with sensors.

The term “AR” means augmented reality, which is a technology that superimposes a computer-generated image on a user's view of the real world, thus providing a composite view.

The term “MR” means mixed reality is a blend of physical and virtual worlds that includes both real and computer-generated objects. The two worlds are “mixed” together to create a realistic environment. A user can navigate this environment and interact with both real and virtual objects. Mixed reality (MR) combines aspects of virtual reality (VR) and augmented reality (AR). It sometimes called “enhanced” AR since it is similar to AR technology, but provides more physical interaction.

The term “XR” means extended reality and refers to all real-and-virtual combined environments and human-machine interactions generated by computer technology and wearables. The levels of virtuality range from partially sensory inputs to immersion virtuality, also called VR.

The terms VR is generally used to mean environments that are totally computer generated, while AR, MR, and XR are sometimes used interchangeable to mean any environment that includes real content and virtual or computer generated content. We will often use the AR/MR/XR as a general term for all environments that including real content and virtual or computer generated content, and these terms may be used interchangeably.

The term “mobile device(s)” means any device including a processing unit, communication hardware and software, one or more input devices, and one or more output devices that may be easily carried by a human or animal such as cell phones, smart phones, wearable devices, tablet computers, laptop computers, or other similar mobile devices.

The term “stationary device(s)” means any device including a processing unit, communication hardware and software, one or more input devices, and one or more output devices that are difficult to be carried by a human or animal such as desktop computers, computer servers, supercomputers, quantum computers, compute server centers, or other similar stationary devices.

The term “hot spots” or “hot spot activation objects” are interactive points where content may be displayed, added, and may have multiple layers or lists or menus, to any point in space (virtual or real). The hot spots or hot spot activation objects may include documents, pictures, video files, audio files, hyperlinks, or any other type of material, information, and/or data associated with the location or time associated with the hot spots or hot spot activation objects.

### DETAILED DESCRIPTION OF THE DISCLOSURE

Embodiments of this disclosure provide apparatuses and/or systems and interfaces and/or methods implementing them, the apparatuses and/or systems comprising an electronic device including one or more processing units, one or more memory units, one or more storage devices, one or more input devices, one or more output devices, an operating system or structure, software and configuration-based protocols and/or elements, communication software and hardware, and routines for implementing the systems/apparatuses, wherein the systems/apparatuses are configured to: for creating, interacting, modifying, and updating 360 environments, the environments including a 360 display output overlaid with selectable and modifiable live feed panels and selectable and modifiable informational hot spots

Embodiments of this disclosure provide apparatuses, systems, and interfaces and methods implementing them for creating, interacting, modifying, and updating 360 environments, the environments including a 360 display output overlaid with selectable and modifiable live feed panels and selectable and modifiable informational hot spots, wherein one or more 360 cameras mounted in a site or location produces one or more continuous 360 outputs of the site or location, the site or location includes a number of visual output or display devices, each of the visual output or display devices include a panel overlaid on the device and linked to that device output, wherein the panels or hot spots may be activated, selected, altered, modified, and/or manipulated using hard selection protocols, motion based protocols without hard selection protocols, or any combination thereof.

Embodiments of this disclosure provide apparatuses, systems, and interfaces and methods implementing them for creating, interacting, modifying, and updating 360 environments, the environments including a 360 display output overlaid with selectable and modifiable live feed panels and selectable and modifiable informational hot spots, wherein one or more 360 cameras mounted in a site or location produces one or more continuous 360 outputs of the site or location, the site or location includes a number of visual output or display devices, each of the visual output or display devices include a panel overlaid on the device and linked to that device output, wherein each of the panels are partially transparent becoming more opaque as that panel is selected, the site includes a plurality of active locations or hot spots within the site that when activated display information about each of the active locations or hot spots, and wherein the panels or active locations may be selected using hard selection protocols, motion based protocols without hard selection protocols, or any combination thereof.

### Motion-Based Attractive/Manipulative Object Selection

Embodiments of the disclosure relate to selection attractive or manipulative apparatuses, systems, and/or interfaces may be constructed that use motion or movement within an active sensor zone of a motion sensor translated to motion or movement of a selection object on or within a user feedback device: 1) to discriminate between selectable objects based on the motion, 2) to attract target selectable objects towards the selection object based on properties of the sensed motion including direction, speed, acceleration, or changes thereof, and 3) to select and simultaneously activate a particular or target selectable object or a specific group of selectable objects or controllable area or an attribute or attributes upon “contact” of the selection object with the target selectable object(s), where contact means that: 1) the selection object actually touches or moves inside the target selectable object, 2) touches or moves inside an active zone (area or volume) surrounding the target selectable object, 3) the selection object and the target selectable object merge, 4) a triggering event occurs based on a close approach to the target selectable object or its associated active zone or 5) a triggering event based on a predicted selection meeting a threshold certainty or relationship with other object(s) or thresholds that are associated with these. Is this an example of a reaching a probability threshold or confidence metric?. The touch, merge, or triggering event causes the processing unit to select and activate the object, select and active object attribute lists, select, activate and adjustments of an adjustable attribute. The objects may represent real, virtual objects, systems, programs, software elements or methods, algorithmic expressions, values or probabilities, containers that can be used by any data, and/or content or generated results of any systems, including: 1) real-world devices under the control of the apparatuses, systems, or interfaces, 2) real-world device attributes and real-world device controllable attributes, 3) software including software products, software systems, software components, software objects, software attributes, active areas of sensors, artificial intelligence methods, data or associated elements, neural networks or elements thereof, databases and database elements, cloud systems, architectures and elements thereof, 4) generated emf fields, Rf fields, microwave fields, or other generated fields, 5) electromagnetic waveforms, sonic waveforms, ultrasonic waveforms, and/or 6) mixture and combinations thereof. The apparatuses, systems and interfaces of this disclosure may also include remote control units in wired or wireless communication therewith. The inventor has also found that a velocity (speed and direction) of motion or movement can be used by the apparatuses, systems, or interfaces to pull or attract one or a group of selectable objects toward a selection object and increasing speed may be used to increase a rate of the attraction of the objects, while decreasing motion speed may be used to slower a rate of attraction of the objects. The inventors have also found that as the attracted object move toward the selection object, they may be augmented in some way such as changed size, changed color, changed shape, changed line thickness of the form of the object, highlighted, changed to blinking, or combinations thereof. Simultaneously, synchronously or asynchronously, submenus or subobjects may also move or change in relation to the movements or changes of the selected objects. Simultaneously, synchronously or asynchronously, the non-selected objects may move away from the selection object(s). It should be noted that whenever a word object is used, it also includes the meaning of objects, and these objects may be single, groups, or families of objects, groups of these with each other, may be simultaneously performing separate, simultaneous, and/or combined command functions or used by the processing units to issue combinational functions, and may remain independent or non-independent and configurable according any needs or intents.

in certain embodiments, as the selection object moves toward a target object, the target object will get bigger as it moves toward the selection object. It is important to conceptualize the effect we are looking for. The effect may be analogized to the effects of gravity on objects in space. Two objects in space are attracted to each other by gravity proportional to the product of their masses and inversely proportional to the square of the distance between the objects. As the objects move toward each other, the gravitational force increases pulling them toward each other faster and faster. The rate of attraction increases as the distance decreases, and they become larger as they get closer. Contrarily, if the objects are close and one is moved away, the gravitational force decreases and the objects get smaller. In the present disclosure, motion of the selection object away from a selectable object may act as a rest, returning the display back to the original selection screen or back to the last selection screen much like a “back” or “undo” event. Thus, if the user feedback unit (e.g., display) is one level down from the top display, then movement away from any selectable object, would restore the display back to the main level. If the display was at some sublevel, then movement away from selectable objects in this sublevel would move up a sublevel. Thus, motion away from selectable objects acts to drill up, while motion toward selectable objects that have sublevels results in a drill down operation. Of course, if the selectable object is directly activatable, then motion toward it selects and activates it. Thus, if the object is an executable routine such as taking a picture, then contact with the selection object, contact with its active area, or triggered by a predictive threshold certainty selection selects and simultaneously activates the object. Once the interface is activated, the selection object and a default menu of items may be activated on or within the user feedback unit. If the direction of motion towards the selectable object or proximity to the active area around the selectable object is such that the probability of selection is increased, the default menu of items may appear or move into a selectable position, or take the place of the initial object before the object is actually selected such that by moving into the active area or by moving in a direction such that a commit to the object occurs, and simultaneously causes the subobjects or submenus to move into a position ready to be selected by just moving in their direction to cause selection or activation or both, or by moving in their direction until reaching an active area in proximity to the objects such that selection, activation or a combination of the two occurs. The selection object and the selectable objects (menu objects) are each assigned a mass equivalent or gravitational value of 1. The difference between what happens as the selection object moves in the display area towards a selectable object in the present interface, as opposed to real life, is that the selectable objects only feel the gravitation effect from the selection object and not from the other selectable objects. Thus, in the present disclosure, the selectable object is an attractor, while the selectable objects are non-interactive, or possibly even repulsive to each other. So as the selection object is moved in response to motion by a user within the motion sensors active zone—such as motion of a finger in the active zone—the processing unit maps the motion and generates corresponding movement or motion of the selection object towards selectable objects in the general direction of the motion. The processing unit then determines the projected direction of motion and based on the projected direction of motion, allows the gravitational field or attractive force of the selection object to be felt by the predicted selectable object or objects that are most closely aligned with the direction of motion. These objects may also include submenus or subobjects that move in relation to the movement of the selected object(s). This effect would be much like a field moving and expanding or fields interacting with fields, where the objects inside the field(s) would spread apart and move such that unique angles from the selection object become present so movement towards a selectable object or group of objects can be discerned from movement towards a different object or group of objects, or continued motion in the direction of the second or more of objects in a line would cause the objects to not be selected that had been touched or had close proximity, but rather the selection would be made when the motion stops, or the last object in the direction of motion is reached, and it would be selected. The processing unit causes the display to move those object toward the selectable object. The manner in which the selectable object moves may be to move at a constant velocity towards a selection object or to accelerate toward the selection object with the magnitude of the acceleration increasing as the movement focuses in on the selectable object. The distance moved by the person and the speed or acceleration may further compound the rate of attraction or movement of the selectable object towards the selection object. In certain situations, a negative attractive force or gravitational effect may be used when it is more desired that the selected objects move away from the user. Such motion of the objects would be opposite of that described above as attractive. As motion continues, the processing unit is able to better discriminate between competing selectable objects and the one or ones more closely aligned are pulled closer and separated, while others recede back to their original positions or are removed or fade. If the motion is directly toward a particular selectable object with a certainty above a threshold value, which has a certainty of greater than 50%, then the selection and selectable objects merge and the selectable object is simultaneously selected and activated. Alternatively, the selectable object may be selected prior to merging with the selection object if the direction, speed and/or acceleration of the selection object is such that the probability of the selectable object is enough to cause selection, or if the movement is such that proximity to the activation area surrounding the selectable object is such that the threshold for selection, activation or both occurs. Motion continues until the processing unit is able to determine that a selectable object has a selection threshold of greater than 50%, meaning that it more likely than not the correct target object has been selected. In certain embodiments, the selection threshold will be at least 60%. In other embodiments, the selection threshold will be at least 70%. In other embodiments, the selection threshold will be at least 80%. In yet other embodiments, the selection threshold will be at least 90%. Of course, all these effects, animations, attributes, embodiments, configurations, and any other kinds of relationships with objects, users and environments may be of any kind being used today or that which is to be invented later.

in certain embodiments, the selection object will actually appear on the display screen, while in other embodiments, the selection object will exist only virtually in the processor software. For example, for motion sensors that require physical contact for activation such as touch screens, the selection object may be displayed and/or virtual, with motion on the screen used to determine which selectable objects from a default collection of selectable objects will be moved toward a perceived or predefined location of a virtual section object or toward the selection object in the case of a displayed selection object, while a virtual object simply exists in software such as at a center of the display or a default position to which selectable object are attracted, when the motion aligns with their locations on the default selection. In the case of motion sensors that have active zones such as cameras, IR sensors, sonic sensors, or other sensors capable of detecting motion within an active zone and creating an output representing that motion to a processing unit that is capable of determining direction, speed and/or acceleration properties of the sensed or detected motion, the selection object is generally virtual and motion of one or more body parts of a user is used to attract a selectable object or a group of selectable objects to the location of the selection object and predictive software is used to narrow the group of selectable objects and zero in on a particular selectable object, objects, objects and attributes, and/or attributes. In certain embodiments, the interface is activated from a sleep condition by movement of a user or user body part in to the active zone of the motion sensor or sensors associated with the interface. Once activated, the feedback unit such as a display associated with the interface displays or evidences in a user discernible manner a default set of selectable objects or a top level set of selectable objects. The selectable objects may be clustered in related groups of similar objects or evenly distributed about a centroid of attraction if no selection object is generated on the display or in or on another type of feedback unit. If one motion sensor is sensitive to eye motion, then motion of the eyes will be used to attract and discriminate between potential target objects on the feedback unit such as a display screen. If the interface is an eye only interface, then eye motion is used to attract and discriminate selectable objects to the centroid, with selection and activation occurring when a selection threshold is exceeded—greater than 50% confidence that one selectable object or group or configurable relationship is more closely aligned with the direction of motion than all other objects. The speed and/or acceleration of the motion along with the direction are further used to enhance discrimination by pulling potential target objects toward the centroid quicker and increasing their size and/or increasing their relative separation. Proximity to the selectable object may also be used to confirm the selection. Alternatively, if the interface is an eye and other body part interface, then eye motion will act as the primary motion driver, with motion of the other body part acting as a confirmation of eye movement selections. Thus, if eye motion has narrowed the selectable objects to a group, motion of the other body part may be used by the processing unit to further discriminate and/or select/activate a particular object or if a particular object meets the threshold and is merging with the centroid, then motion of the object body part may be used to confirm or reject the selection regardless of the threshold confidence. In other embodiments, the motion sensor and processing unit may have a set of predetermined actions that are invoked by a given structure of a body part or a given combined motion of two or more body parts. For example, upon activation, if the motion sensor is capable of analyzing images, a hand holding up different number of figures from zero, a fist, to five, an open hand may cause the processing unit to display different base menus. For example, a fist may cause the processing unit to display the top level menu, while a single finger may cause the processing unit to display a particular submenu. Once a particular set of selectable objects is displayed, then motion attracts the target object, which is simultaneously selected and activated. In other embodiments, confirmation may include a noised generated by the uses such as a word, a vocal noise, a predefined vocal noise, a clap, a snap, or other audio controlled sound generated by the user; in other embodiments, confirmation may be visual, audio or haptic effects or a combination of such effects.

Embodiments of this disclosure provide methods and systems implementing the methods comprising the steps of sensing circular movement via a motion sensor, where the circular movement is sufficient to activate a scroll wheel, or scrollable function, list function, navigation or control function, scrolling through a list, matrix, field or any scrollable or listable entity or content associated with the scroll wheel, where movement close to the center causes a faster scroll, while movement further from the center causes a slower scroll and simultaneously faster circular movement causes a faster scroll while slower circular movement causes slower scroll. When the user stops the circular motion, even for a very brief time, the list becomes static so that the user may move to a particular object, hold over a particular object, or change motion direction at or near a particular object. The whole wheel or a partial amount of the wheel may be displayed, or just and arc may be displayed where scrolling moves up and down the arc. These actions cause the processing unit to select the particular object, to simultaneously select and activate the particular object, or to simultaneously select, activate, and control an attribute of the object. By beginning the circular motion again, anywhere on the screen, scrolling recommences immediately. Of course, scrolling could be through a list of values, or actually be controlling values as well.

Embodiments of the present disclosure also provide methods and systems implementing the methods including the steps of displaying an arcuate menu layouts of selectable objects on a display field, sensing movement toward an object pulling the object toward the center based on a direction, a speed and/or an acceleration of the movement, as the selected object moves toward the center, displaying subobjects appear distributed in an arcuate spaced apart configuration about the selected object. The apparatus, system and methods can repeat the sensing and displaying operations.

Embodiments of this disclosure relate to methods and systems for implementing the methods comprising the steps of predicting an object's selection based on the properties of the sensed movement, where the properties include distance, time, configuration, direction, speed, acceleration, changes thereof, or combinations thereof. For example, faster speed may increase predictability, while slower speed may decrease predictability or vis a versa. Alternatively, moving averages may be used to extrapolate the desired object desired. Along with this is the “gravitational”, “electric” and/or “magnetic” attractive or repulsive effects utilized by the methods and systems, whereby the selectable objects move towards the user or selection object and accelerates towards the user or selection object as the user or selection object and selectable objects come closer together. This may also occur by the user beginning motion towards a particular selectable object, the particular selectable object begins to accelerate towards the user or the selection object, and the user and the selection object stops moving, but the particular selectable object continues to accelerate towards the user or selection object. In the certain embodiments, the opposite effect occurs as the user or selection objects moves away—starting close to each other, the particular selectable object moves away quickly, but slows down its rate of repulsion as distance is increased, making a very smooth look. In different uses, the particular selectable object might accelerate away or return immediately to it's original or predetermined position. In any of these circumstances, a dynamic interaction is occurring between the user or selection object and the particular selectable object(s), where selecting and controlling, and deselecting and controlling can occur, including selecting and controlling or deselecting and controlling associated submenus or subobjects and/or associated attributes, adjustable, invocable, and/or the relationships between these.

Embodiments of this disclosure relate to methods and systems for implementing the methods comprising the steps of detecting at least one bio-kinetic characteristic of a user such as a fingerprint, fingerprints, a palm print, retinal print, size, shape, and texture of fingers, palm, eye(s), hand(s), face, etc. or at least one EMF, acoustic, thermal or optical characteristic detectable by sonic sensors, thermal sensors, optical sensors, capacitive sensors, resistive sensors, or other sensor capable of detecting EMF fields, optical, thermal, or other characteristics, or combinations thereof emanating from a user, including specific movements and measurements of movements of body parts such as fingers or eyes that provide unique markers for each individual, determining an identity of the user from the bio-kinetic characteristics, and sensing movement as set forth herein. In this way, the existing sensor for motion may also recognize the user uniquely. This recognition may be further enhanced by using two or more body parts or bio-kinetic characteristics (e.g., two fingers), and even further by body parts performing a particular task such as being squeezed together, when the user enters in a sensor field. Other bio-kinetic and/or biometric characteristics may also be used for unique user identification such as skin characteristics and ratio to joint length and spacing. Further examples include the relationship between the finger(s), hands or other body parts and the interference pattern created by the body parts creates a unique constant and may be used as a unique digital signature. For instance, a finger in a 3D acoustic or EMF field would create unique null and peak points or a unique null and peak pattern, so the “noise” of interacting with a field may actually help to create unique identifiers. This may be further discriminated by moving a certain distance, where the motion may be uniquely identified by small tremors, variations, or the like, further magnified by interference patterns in the noise. This type of unique identification is most apparent when using a touchless sensor or array of touchless sensors, where interference patterns (for example using acoustic sensors) may be present due to the size and shape of the hands or fingers, or the like. Further uniqueness may be determined by including motion as another unique variable, which may help in security verification.

Embodiments of this disclosure relate to methods and systems for implementing the methods comprising the steps of sensing movement of a first body part such as an eye, etc., tracking the first body part movement until is pauses on an object, preliminarily selecting the object, sensing movement of a second body part such as finger, hand, foot, etc., confirming the preliminary selection and selecting the object. The selection may then cause the processing unit to invoke one of the command and control functions including issuing a scroll function, a simultaneous select and scroll function, a simultaneous select and activate function, a simultaneous select, activate, and attribute adjustment function, or a combination thereof, and controlling attributes by further movement of the first or second body parts or activating the objects if the object is subject to direct activation. These selection procedures may be expanded to the eye moving to an object (scrolling through a list or over a list), the finger or hand moving in a direction to confirm the selection and selecting an object or a group of objects or an attribute or a group of attributes. In certain embodiments, if object configuration is predetermined such that an object in the middle of several objects, then the eye may move somewhere else, but hand motion continues to scroll or control attributes or combinations thereof, independent of the eyes. Hand and eyes may work together or independently, or a combination in and out of the two. Thus, movements may be compound, sequential, simultaneous, partially compound, compound in part, or combinations thereof.

Embodiments of this disclosure relate to methods and systems for implementing the methods comprising the steps of capturing a movement of a user during a selection procedure or a plurality of selection procedures to produce a raw movement dataset. The methods and systems also include the step of reducing the raw movement dataset to produce a refined movement dataset, where the refinement may include reducing the movement to a plurality of linked vectors, to a fit curve, to a spline fit curve, to any other curve fitting format having reduced storage size, or to any other fitting format. The methods and systems also include the step of storing the refined movement dataset. The methods and systems also include the step of analyzing the refined movement dataset to produce a predictive tool for improving the prediction of a users selection procedure using the motion-based system or to produce a forensic tool for identifying the past behavior of the user or to process a training tools for training the user interface to improve user interaction with the interface.

Embodiments of this disclosure relate to methods and systems for implementing the methods comprising the steps of sensing movement of a plurality of body parts simultaneously or substantially simultaneously and converting the sensed movement into control functions for simultaneously controlling an object or a plurality of objects. The methods and systems also include controlling an attribute or a plurality of attributes, or activating an object or a plurality of objects, or any combination thereof. For example, placing a hand on a top of a domed surface for controlling a UAV, sensing movement of the hand on the dome, where a direction of movement correlates with a direction of flight, sensing changes in the movement on the top of the domed surface, where the changes correlate with changes in direction, speed, or acceleration of functions, and simultaneously sensing movement of one or more fingers, where movement of the fingers may control other features of the UAV such as pitch, yaw, roll, camera focusing, missile firing, etc. with an independent finger(s) movement, while the hand is controlling the UAV, either through remaining stationary (continuing last known command) or while the hand is moving, accelerating, or changing direction of acceleration. In certain embodiments where the display device is flexible device such as a flexible screen or flexible dome, the movement may also include deforming the surface of the flexible device, changing a pressure on the surface, or similar surface deformations. These deformations may be used in conjunction with the other motions.

Embodiments of this disclosure relate to methods and systems for implementing the methods comprising the steps of populating a display field with displayed primary objects and hidden secondary objects, where the primary objects include menus, programs, devices, etc. and secondary objects include submenus, attributes, preferences, etc. The methods and systems also include sensing movement, highlighting one or more primary objects most closely aligned with a direction of the movement, predicting a primary object based on the movement, and simultaneously: (a) selecting the primary object, (b) displaying secondary objects most closely aligned with the direction of motion in a spaced apart configuration, (c) pulling the primary and secondary objects toward a center of the display field or to a pre-determined area of the display field, and (d) removing, fading, or making inactive the unselected primary and secondary objects until making active again.

Alternately, zones in between primary and/or secondary objects may act as activating areas or subroutines that would act the same as the objects. For instance, if someone were to move in between two objects in 3D space, objects in the background could be rotated to the front and the front objects could be rotated towards the back, or to a different level.

Embodiments of this disclosure relate to methods and systems for implementing the methods comprising the steps of populating a display field with displayed primary objects and offset active fields associated with the displayed primary objects, where the primary objects include menus, object lists, alphabetic characters, numeric characters, symbol characters, other text based characters. The methods and systems also include sensing movement, highlighting one or more primary objects most closely aligned with a direction of the movement, predicting a primary object based on the movement, and simultaneously: (a) selecting the primary object, (b) displaying secondary (tertiary or deeper) objects most closely aligned with the direction of motion in a spaced apart configuration, (c) pulling the primary and secondary or deeper objects toward a center of the display field or to a pre-determined area of the display field, and/or (d) removing, making inactive, or fading or otherwise, indicating non-selection status of the unselected primary, secondary, and deeper level objects.

Embodiments of this disclosure relate to methods and systems for implementing the methods comprising the steps of sensing movement of an eye and simultaneously moving elements of a list within a fixed window or viewing pane of a display field or a display or an active object hidden or visible through elements arranged in a 2D or 3D matrix within the display field, where eye movement anywhere, in any direction in a display field regardless of the arrangement of elements such as icons moves through the set of selectable objects. Of course the window may be moved with the movement of the eye to accomplish the same scrolling through a set of lists or objects, or a different result may occur by the use of both eye position in relation to a display or volume (perspective), as other motions occur, simultaneously or sequentially. Thus, scrolling does not have to be in a linear fashion, the intent is to select an object and/or attribute and/or other selectable items regardless of the manner of motion—linear, arcuate, angular, circular, spiral, random, or the like. Once an object of interest is to be selected, then selection is accomplished either by movement of the eye in a different direction, holding the eye in place for a period of time over an object, movement of a different body part, or any other movement or movement type that affects the selection of an object or audio event, facial posture, or biometric or bio-kinetic event.

Embodiments of this disclosure relate to methods and systems for implementing the methods comprising the steps of sensing movement of a gaze (e.g., an eye or head gaze or both), selecting an object, an object attribute or both by moving the gaze and/or eye movement in a pre-described change of direction such that the change of direction would be known and be different than a random gaze and/or eye movement, or a movement associated with the scroll (scroll being defined by moving the gaze and/or eye movement all over the screen or volume of objects with the intent to choose).

Embodiments of this disclosure relate to methods and systems for implementing the methods comprising the steps of sensing eye movement via a motion sensor, selecting an object displayed in a display field when the gaze and/or eye movement pauses at an object for a dwell time sufficient for the motion sensor to detect the pause and simultaneously activating the selected object, repeating the sensing and selecting until the object is either activatable or an attribute capable of direct control. In certain embodiments, the methods also comprise predicting the object to be selected from characteristics of the movement and/or characteristics of the manner in which the user moves. In other embodiments, eye tracking—using gaze instead of motion for selection/control via eye focusing (dwell time or gaze time) on an object and a body motion (finger, hand, etc.) scrolls through an associated attribute list associated with the object, or selects a submenu associated with the object. Eye gaze selects a submenu object and body motion confirms selection (selection does not occur without body motion), so body motion actually affects object selection, or any combination of body movement, gaze, and/or eye movement.

In other embodiments, eye tracking—using motion for selection/control—eye movement is used to select a first word in a sentence of a word document. Selection is confirmed by body motion of a finger (e.g., right finger) which holds the position. Eye movement is then tracked to the last word in the sentence and another finger (e.g., the left finger) confirms selection. Selected sentence is highlighted due to second motion defining the boundary of selection. The same effect may be had by moving the same finger towards the second eye position (the end of the sentence or word). Movement of one of the fingers towards the side of the monitor (movement is in different direction than the confirmation movement) sends a command to delete the sentence. Alternatively, movement of eye to a different location, followed by both fingers moving generally towards that location results in the sentence being copied to the location at which the eyes stopped. This may also be used in combination with a gesture or with combinations of motions and gestures such as eye movement and other body movements concurrently—multiple inputs at once such as UAV controls described below, and the head or any body part(s) or object, system or intelligence under control of the remote can substitute for the fingers.

In other embodiments, looking at the center of picture or article and then moving one finger away from center of picture or center of body enlarges the picture or article (zoom in). Moving finger towards center of picture makes picture smaller (zoom out). What is important to understand here is that an eye gaze point, a direction of gaze, or a motion of the eye provides a reference point for body motion and location to be compared. For instance, moving a body part (say a finger) a certain distance away from the center of a picture in a touch or touchless, 2D or 3D environment (area or volume as well), may provide a different view. For example, if the eye(s) were looking at a central point in an area, one view would appear, while if the eye(s) were looking at an edge point in an area, a different view would appear. The relative distance of the motion would change, and the relative direction may change as well, and even a dynamic change involving both eye(s) and finger, could provide yet another change of motion. For example, by looking at the end of a stick and using the finger to move the other end of it, the pivot point would be the end the eyes were looking at. By looking at the middle of the stick, then using the finger to rotate the end, the stick would pivot around the middle. Each of these movement may be used to control different attributes of a picture, screen, display, window, or volume of a 3D projection, etc. What now takes two fingers may be replaced by one due to the eye(s) acting as the missing finger.

These concepts are usable to manipulate the view of pictures, images, 3D data or higher dimensional data, 3D renderings, 3D building renderings, 3D plant and facility renderings, or any other type of 3D or higher dimensional pictures, images, or renderings. These manipulations of displays, pictures, screens, etc. may also be performed without the coincidental use of the eye, but rather by using the motion of a finger or object under the control or a user, such as by moving from one lower corner of a bezel, screen, or frame (virtual or real) diagonally to the opposite upper corner to control one attribute, such as zooming in, while moving from one upper corner diagonally to the other lower corner would perform a different function, for example zooming out. This motion may be performed as a gesture, where the attribute change might occur in at predefined levels, or may be controlled variably so the zoom in/out function may be a function of time, space, and/or distance. By moving from one side or edge to another, the same predefined level of change, or variable change may occur on the display, picture, frame, or the like. For example, a TV screen displaying a picture and zoom-in may be performed by moving from a bottom left corner of the frame or bezel, or an identifiable region (even off the screen) to an upper right potion. As the user moves, the picture is magnified (zoom-in). By starting in an upper right corner and moving toward a lower left, the system causes the picture to be reduced in size (zoom-out) in a relational manner to the distance or speed the user moves. If the user makes a quick diagonally downward movement from one upper corner to the other lower corner, the picture may be reduced by 50% (for example). This eliminates the need for using two fingers that is currently popular as a pinch/zoom function. The single finger can be substituted with any body part, remote, intelligence or other force.

By the user moving from a right side of the frame or bezel or predefined location towards a left side, an aspect ratio of the picture may be changed so as to make the picture tall and skinny. By moving from a top edge toward a bottom edge, the picture may cause the picture to appear short and wide. By moving two fingers from one upper corner diagonally towards a lower corner, or from side to side, a “cropping” function may be used to select certain aspects of the picture.

By taking one finger and placing it near the edge of a picture, frame, or bezel, but not so near as to be identified as desiring to use a size or crop control, and moving in a rotational or circular direction, the picture could be rotated variably, or if done in a quick gestural motion, the picture might rotate a predefined amount, for instance 90 degrees left or right, depending on the direction of the motion.

By moving within a central area of a picture, the picture may be moved “panned” variably by a desired amount or panned a preset amount, say 50% of the frame, by making a gestural motion in the direction of desired panning. Likewise, these same motions may be used in a 3D environment for simple manipulation of object attributes. These are not specific motions using predefined pivot points as is currently used in CAD programs but is rather a way of using the body (eyes or fingers for example) in broad areas. These same motions may be applied to any display, projected display or other similar device. In a mobile device, where many icons (objects) exist on one screen, where the icons include folders of “nested” objects, by moving from one lower corner of the device or screen diagonally toward an upper corner, the display may zoom in, meaning the objects would appear magnified, but fewer would be displayed. By moving from an upper right corner diagonally downward, the icons would become smaller, and more could be seen on the same display. Moving in a circular motion near an edge of the display may cause rotation of the icons, providing scrolling through lists and pages of icons. Moving from one edge to an opposite edge would change the aspect ratio of the displayed objects, making the screen of icons appear shorter and wider, or taller and skinny, based on the direction moved.

In other embodiments, looking at a menu object then moving a finger away from object or center of body opens up sub menus. If the object represents a software program such as excel, moving away opens up spreadsheet fully or variably depending on how much movement is made (expanding spreadsheet window).

In other embodiments, instead of being a program accessed through an icon, the program may occupy part of a 3D space that the user interacts with the program or a field coupled to the program acting as a sensor for the program through which the user to interacts with the program. In other embodiments, if object represents a software program such as Excel and several (say 4) spreadsheets are open at once, movement away from the object shows 4 spread sheet icons. The effect is much like pulling curtain away from a window to reveal the software programs that are opened. The software programs might be represented as “dynamic fields”, each program with its own color, say red for excel, blue for word, etc. The objects or aspects or attributes of each field may be manipulated by using motion. For instance, if a center of the field is considered to be an origin of a volumetric space about the objects or value, moving at an exterior of the field cause a compound effect on the volume as a whole due to having a greater x value, a greater y value, or a great z value—say the maximum value of the field is 5 (x, y, or z), moving at a 5 point would be a multiplier effect of 5 compared to moving at a value of 1 (x, y, or z). The inverse may also be used, where moving at a greater distance from the origin may provide less of an effect on part or the whole of the field and corresponding values. Changes in color, shape, size, density, audio characteristics, or any combination of these and other forms of representation of values could occur, which may also help the user or users to understand the effects of motion on the fields. These may be preview panes of the spreadsheets or any other icons representing these. Moving back through each icon or moving the finger through each icon or preview pane, then moving away from the icon or center of the body selects the open programs and expands them equally on the desktop, or layers them on top of each other, etc.

In other embodiments, four Word Documents (or any program or web pages) are open at once. Movement from bottom right of the screen to top left reveals the document at bottom right of page, effect looks like pulling curtain back. Moving from top right to bottom left reveals a different document. Moving from across the top, and circling back across the bottom opens all, each in its quadrant, then moving through the desired documents and creating circle through the objects links them all together and merges the documents into one document. As another example, the user opens three spreadsheets and dynamically combines or separates the spreadsheets merely via motions or movements, variably per amount and direction of the motion or movement. Again, the software or virtual objects are dynamic fields, where moving in one area of the field may have a different result than moving in another area, and the combining or moving through the fields causes a combining of the software programs, and may be done dynamically. Furthermore, using the eyes to help identify specific points in the fields (2D or 3D) would aid in defining the appropriate layer or area of the software program (field) to be manipulated or interacted with. Dynamic layers within these fields may be represented and interacted with spatially in this manner. Some or all the objects may be affected proportionately or in some manner by the movement of one or more other objects in or near the field. Of course, the eyes may work in the same manner as a body part, or in combination with other objects or body parts.

In other embodiments, the eye selects (acts like a cursor hovering over an object and object may or may not respond, such as changing color to identify it has been selected), then a motion or gesture of eye or a different body part confirms and disengages the eyes for further processing.

In other embodiments, the eye selects or tracks and a motion or movement or gesture of second body part causes a change in an attribute of the tracked object—such as popping or destroying the object, zooming, changing the color of the object, etc. finger is still in control of the object.

In other embodiments, eye selects, and when body motion and eye motion are used, working simultaneously or sequentially, a different result occurs compared to when eye motion is independent of body motion, e.g., eye(s) tracks a bubble, finger moves to zoom, movement of the finger selects the bubble and now eye movement will rotate the bubble based upon the point of gaze or change an attribute of the bubble, or the eye may gaze and select and/or control a different object while the finger continues selection and/or control of the first objector a sequential combination could occur, such as first pointing with the finger, then gazing at a section of the bubble may produce a different result than looking first and then moving a finger; again a further difference may occur by using eyes, then a finger, then two fingers than would occur by using the same body parts in a different order.

Other embodiments of this disclosure relate to methods and systems for implementing the methods comprising the steps of: controlling helicopter with one hand on a domed interface, where several fingers and hand all move together and move separately. In this way, the whole movement of the hand controls the movement of the helicopter in yaw, pitch and roll, while the fingers may also move simultaneously to control cameras, artillery, or other controls or attributes, or both. This is movement of multiple inputs simultaneously congruently or independently.

Note—we have not discussed the perspective of the user as gravitational effects and object selections are made in 3D space. For instance, as we move in 3D space towards subobjects, using our previously submitted gravitational and predictive effects, each selection may change the entire perspective of the user so the next choices are in the center of view or in the best perspective. This may include rotational aspects of perspective, the goal being to keep the required movement of the user small and as centered as possible in the interface real estate. This is really showing the aspect of the user, and is relative. Since we are saying the objects and fields may be moved, or saying the user may move around the field, it is really a relative.

Other embodiments of this disclosure relate to methods and systems for implementing the methods comprising the steps of sensing movement of a button or knob with motion controls associated therewith, either on top of or in 3D, 3 space, on sides (whatever the shape), predicting which gestures are called by direction and speed of motion (maybe amendment to gravitational/predictive application). By definition, a gesture has a pose-movement-pose then lookup table, then command if values equal values in lookup table. We can start with a pose, and predict the gesture by beginning to move in the direction of the final pose. As we continue to move, we would be scrolling through a list of predicted gestures until we can find the most probable desired gesture, causing the command of the gesture to be triggered before the gesture is completed. Predicted gestures could be dynamically shown in a list of choices and represented by objects or text or colors or by some other means in a display. As we continue to move, predicted end results of gestures would be dynamically displayed and located in such a place that once the correct one appears, movement towards that object, representing the correct gesture, would select and activate the gestural command. In this way, a gesture could be predicted and executed before the totality of the gesture is completed, increasing speed and providing more variables for the user.

For example, in a keyboard application, current software use shapes of gestures to predict words. Google uses zones of letters (a group of letters), and combinations of zones (gestures) to predict words. We would use the same gesture-based system, except we be able to predict which zone the user is moving towards based upon direction of motion, meaning we would not have to actually move into the zone to finish the gesture, but moving towards the zone would bring up choice bubbles, and moving towards the bubble would select that bubble.

In another example, instead of using a gesture such as “a pinch” gesture to select something in a touchless environment, movement towards making that gesture would actually trigger the same command. So instead of having to actually touch the finger to the thumb, just moving the finger towards the thumb would cause the same effect to occur. Most helpful in combination gestures where a finger pointing gesture is followed by a pinching gesture to then move a virtual object. By predicting the gesture, after the point gesture, the beginning movement of the pinch gesture would be faster than having to finalize the pinching motion.

Other embodiments of this disclosure relate to methods and systems for implementing the methods comprising the steps of: sensing movement via a motion sensor within a display field displaying a list of letters from an alphabet, predicting a letter or a group of letters based on the motion, if movement is aligned with a single letter, simultaneously select the letter or simultaneously moving the group of letter forward until a discrimination between letters in the group is predictively certain and simultaneously select the letter, sensing a change in a direction of motion, predicting a second letter or a second group of letter based on the motion, if movement is aligned with a single letter, simultaneously select the letter or simultaneously moving the group of letter forward until a discrimination between letters in the group is predictively certain and simultaneously select the letter, either after the first letter selection or the second letter selection or both, display a list of potential words beginning with either the first letter or the second letter, selecting a word from the word list by movement of a second body part simultaneously selected the word and resetting the original letter display, and repeating the steps until a message is completed.

Thus, the current design selects a letter simply by changing a direction of movement at or near a letter. A faster process would be to use movement toward a letter, then changing a direction of movement before reaching the letter and moving towards a next letter and changing direction of movement again before getting to the next letter would better predict words, and might change the first letter selection. Selection bubbles would appear and be changing while moving, so speed and direction would be used to predict the word, not necessarily having to move over the exact letter or very close to it, though moving over the exact letter would be a positive selection of that letter and this effect could be better verified by a slight pausing or slowing down of movement. (Of course, this could be combined with current button like actions or lift-off events (touch-up events), and more than one finger or hand may be used, both simultaneously or sequentially to provide the spelling and typing actions.) This is most effective in a touchless environment where relative motion can be leveraged to predict words on a keyboard rather than the actual distance required to move from key to key. The distance from a projected keyboard and movement of finger uses angles of motion to predict letters. Predictive word bubbles can be selected with a Z movement. B) Move below the letters of a keyboard to select, or shape the letter buttons in such a way that they extend downward (like a tear drop) so actual letters can be seen while selecting instead of covering the letters (the touch or active zones are offset from the actual keys. This can also be used with predictive motions to create a very fast keyboard where relative motions are used to predict keys and words while more easily being able to see the key letters. Bubbles could also appear above or besides the keys, or around them, including in a arcuate or radial fashion to further select predicted results by moving towards the suggested words.

Other embodiments of this disclosure relate to methods and systems for implementing the methods comprising the steps of: maintaining all software applications in an instant on configuration—on, but inactive, resident, but not active, so that once selected the application which is merely dormant, is fully activate instantaneously (or may be described as a different focus of the object), sensing movement via a motion sensor with a display field including application objects distributed on the display in a spaced apart configuration, preferably, in a maximally spaced apart configuration so that the movement results in a fast predict selection of an application object, pulling an application object or a group of application objects toward a center of the display field, if movement is aligned with a single application, simultaneously select and instant on the application, or continue monitoring the movement until a discrimination between application objects is predictively certain and simultaneously selecting and activating the application object.

Thus, the industry must begin to start looking at everything as always on and what is on is always interactive, and may have different levels of interactivity. For instance, software should be an interactive field. Excel and word should be interactive fields where motion through them can combine or select areas, which correspond to cells and texts being intertwined with the motion. Excel sheets should be part of the same 3D field, not separate pages, and should have depth so their aspects can be combined in volume. The software desktop experience needs a depth where the desktop is the cover of a volume, and rolling back the desktop from different corners reveals different programs that are active and have different colors, such as word being revealed when moving from bottom right to top left and being a blue field, excel being revealed when moving from top left to bottom right and being red; moving right to left lifts desktop cover and reveals all applications in volume, each application with its own field and color in 3D space.

Other embodiments of this disclosure relate to methods and systems of this disclosure, where the active screen area includes a delete or backspace region. When the user moves the active object (cursor) toward the delete or backspace region, then the selected objects will be released one at a time or in groups or completely depending on attributes of movement toward the delete of backspace region. Thus, if the movement is slow and steady, then the selected objects are released one at a time. If the movement is fast, then multiple selected objects are released. Thus, the delete or backspace region is variable. For example, if the active display region represents a cell phone dialing pad (with the number distributed in any desired configuration from a traditional grid configuration to a arcuate configuration about the active object, or in any other desirable configuration), when by moving the active object toward the delete or backspace region, numbers will be removed from the number, which may be displayed in a number display region of the display. Alternatively, touching the backspace region would back up one letter; moving from right to left in the backspace region would delete (backspace) a corresponding amount of letters based on the distance (and/or speed) of the movement, The deletion could occur when the motion is stopped, paused, or a lift off event is detected. Alternatively, a swiping motion (jerk, or fast acceleration) could result in the deletion (backspace) the entire word. All these may or may not require a lift off event, but the motion dictates the amount deleted or released objects such as letters, numbers, or other types of objects. The same is true with the delete key, except the direction would be forward instead of backwards. Lastly, the same could be true in a radial menu (or linear or spatial), where the initial direction of motion towards an object or on an object, or in a zone associated with an object, that has a variable attribute. The motion associated with or towards that object would provide immediate control.

Other embodiments of this disclosure relate to methods and systems of this disclosure, where eye movement is used to select and body part movement is used to confirm or activate the selection. Thus, eye movement is used as the selective movement, while the object remains in the selected state, then the body part movement confirms the selection and activates the selected object. Thus, specifically stated the eye or eyes look in a different direction or area, and the last selected object would remain selected until a different object is selected by motion of the eyes or body, or until a time-out deselects the object. An object may be also selected by an eye gaze, and this selection would continue even when the eye or eyes are no longer looking at the object. The object would remain selected unless a different selectable object is looked at, or unless a timeout deselects the object occurs.

In all of the embodiments set forth above, the motion or movement may also comprise lift off event, where a finger or other body part or parts are in direct contract with a touch sensitive feedback device such as a touch screen, then the acceptable forms of motion or movement will comprise touching the screen, moving on or across the screen, lifting off from the screen (lift off events), holding still on the screen at a particular location, holding still after first contact, holding still after scroll commencement, holding still after attribute adjustment to continue an particular adjustment, holding still for different periods of time, moving fast or slow, moving fast or slow or different periods of time, accelerating or decelerating, accelerating or decelerating for different periods of time, changing direction, changing speed, changing velocity, changing acceleration, changing direction for different periods of time, changing speed for different periods of time, changing velocity for different periods of time, changing acceleration for different periods of time, or any combinations of these motions may be used by the systems and methods to invoke command and control over real-world or virtual world controllable objects using on the motion only. Of course, if certain objects that are invoked by the motion sensitive processing of the systems and methods of this disclosure require hard select protocols—mouse clicks, finger touches, etc., the invoked object's internal function will not be augmented by the systems or methods of this disclosure unless the invoked object permits or supports system integration.

The systems and methods are disclosed herein where command functions for selection and/or control of real and/or virtual objects may be generated based on a change in velocity at constant direction, a change in direction at constant velocity, a change in both direction and velocity, a change in a rate of velocity, or a change in a rate of acceleration. Once detected by an detector or sensor, these changes may be used by a processing unit to issue commands for controlling real and/or virtual objects. A selection or combination scroll, selection, and attribute selection may occur upon the first movement. Such motion may be associated with doors opening and closing in any direction, golf swings, virtual or real-world games, light moving ahead of a runner, but staying with a walker, or any other motion having compound properties such as direction, velocity, acceleration, and changes in any one or all of these primary properties; thus, direction, velocity, and acceleration may be considered primary motion properties, while changes in these primary properties may be considered secondary motion properties. The system may then be capable of differentially handling of primary and secondary motion properties. Thus, the primary properties may cause primary functions to be issued, while secondary properties may cause primary function to be issued, but may also cause the modification of primary function and/or secondary functions to be issued. For example, if a primary function comprises a predetermined selection format, the secondary motion properties may expand or contract the selection format.

In another example of this primary/secondary format for causing the system to generate command functions may involve an object display. Thus, by moving the object in a direction away from the user's eyes, the state of the display may change, such as from a graphic to a combination graphic and text, to a text display only, while moving side to side or moving a finger or eyes from side to side could scroll the displayed objects or change the font or graphic size, while moving the head to a different position in space might reveal or control attributes or submenus of the object. Thus, these changes in motions may be discrete, compounded, or include changes in velocity, acceleration and rates of these changes to provide different results for the user. These examples illustrate two concepts: 1) the ability to have compound motions which provide different results that the motions separately or sequentially, and (2) the ability to change states or attributes, such as graphics to text solely or in combination with single or compound motions, or with multiple inputs, such as verbal, touch, facial expressions, or bio-kinetically, all working together to give different results, or to provide the same results in different ways.

It must be recognized that the present disclosure while based on the use of sensed velocity, acceleration, and changes and rates of changes in these properties to affect control of real-world objects and/or virtual objects, the present disclosure may also use other properties of the sensed motion in combination with sensed velocity, acceleration, and changes in these properties to affect control of real-world and/or virtual objects, where the other properties include direction and change in direction of motion, where the motion has a constant velocity. For example, if the motion sensor(s) senses velocity, acceleration, changes in velocity, changes in acceleration, and/or combinations thereof that is used for primary control of the objects via motion of a primary sensed human, animal, part thereof, real-world object under the control of a human or animal, or robots under control of the human or animal, then sensing motion of a second body part may be used to confirm primary selection protocols or may be used to fine tune the selected command and control function. Thus, if the selection is for a group of objects, then the secondary motion properties may be used to differentially control object attributes to achieve a desired final state of the objects.

For example, suppose the apparatuses of this disclosure control lighting in a building. There are banks of lights on or in all four walls (recessed or mounted) and on or in the ceiling (recessed or mounted). The user has already selected and activated lights from a selection menu using motion to activate the apparatus and motion to select and activate the lights from a list of selectable menu items such as sound system, lights, cameras, video system, etc. Now that lights has been selected from the menu, movement to the right would select and activate the lights on the right wall. Movement straight down would turn all of the lights of the right wall down—dim the lights. Movement straight up would turn all of the lights on the right wall up—brighten. The velocity of the movement down or up would control the rate that the lights were dimmed or brighten. Stopping movement would stop the adjustment or removing the body, body part or object under the user control within the motion sensing area would stop the adjustment.

For even more sophisticated control using motion properties, the user may move within the motion sensor active area to map out a downward concave arc, which would cause the lights on the right wall to dim proportionally to the arc distance from the lights. Thus, the right lights would be more dimmed in the center of the wall and less dimmed toward the ends of the wall.

Alternatively, if the movement was convex downward, then the light would dim with the center being dimmed the least and the ends the most. Concave up and convex up would cause differential brightening of the lights in accord with the nature of the curve.

Now, the apparatus may also use the velocity of the movement of the mapping out the concave or convex movement to further change the dimming or brightening of the lights. Using velocity, starting off slowly and increasing speed in a downward motion would cause the lights on the wall to be dimmed more as the motion moved down. Thus, the lights at one end of the wall would be dimmed less than the lights at the other end of the wall.

Now, suppose that the motion is a S-shape, then the light would be dimmed or brightened in a S-shaped configuration. Again, velocity may be used to change the amount of dimming or brightening in different lights simply by changing the velocity of movement. Thus, by slowing the movement, those lights would be dimmed or brightened less than when the movement is speed up. By changing the rate of velocity—acceleration—further refinements of the lighting configuration may be obtained.

Now suppose that all the lights in the room have been selected, then circular or spiral motion would permit the user to adjust all of the lights, with direction, velocity and acceleration properties being used to dim and/or brighten all the lights in accord with the movement relative to the lights in the room. For the ceiling lights, the circular motion may move up or down in the z direction to affect the luminosity of the ceiling lights. Thus, through the sensing of motion or movement within an active sensor zone—area and especially volume, a user can use simple or complex motion to differentially control large numbers of devices simultaneously.

This differential control through the use of sensed complex motion permits a user to nearly instantaneously change lighting configurations, sound configurations, TV configurations, or any configuration of systems having a plurality of devices being simultaneously controlled or of a single system having a plurality of objects or attributes capable of simultaneous control. For examples, in a computer game including large numbers of virtual objects such as troops, tanks, airplanes, etc., sensed complex motion would permit the user to quickly deploy, redeploy, rearrangement, manipulated and generally quickly reconfigure all controllable objects and/or attributes by simply conforming the movement of the objects to the movement of the user sensed by the motion detector. This same differential device and/or object control would find utility in military and law enforcement, where command personnel by motion or movement within a sensing zone of a motion sensor quickly deploy, redeploy, rearrangement, manipulated and generally quickly reconfigure all assets to address a rapidly changing situation.

Embodiments of systems of this disclosure include a motion sensor or sensor array, where each sensor includes an active zone and where each sensor senses movement, movement direction, movement velocity, and/or movement acceleration, and/or changes in movement direction, changes in movement velocity, and/or changes in movement acceleration, and/or changes in a rate of a change in direction, changes in a rate of a change in velocity and/or changes in a rate of a change in acceleration within the active zone by one or a plurality of body parts or objects and produces an output signal. The systems also include at least one processing unit including communication software and hardware, where the processing units convert the output signal or signals from the motion sensor or sensors into command and control functions, and one or a plurality of real objects and/or virtual objects in communication with the processing units. The command and control functions comprise at least (1) a scroll function or a plurality of scroll functions, (2) a select function or a plurality of select functions, (3) an attribute function or plurality of attribute functions, (4) an attribute control function or a plurality of attribute control functions, or (5) a simultaneous control function. The simultaneous control function includes (a) a select function or a plurality of select functions and a scroll function or a plurality of scroll functions, (b) a select function or a plurality of select functions and an activate function or a plurality of activate functions, and (c) a select function or a plurality of select functions and an attribute control function or a plurality of attribute control functions. The processing unit or units (1) processes a scroll function or a plurality of scroll functions, (2) selects and processes a scroll function or a plurality of scroll functions, (3) selects and activates an object or a plurality of objects in communication with the processing unit, or (4) selects and activates an attribute or a plurality of attributes associated with an object or a plurality of objects in communication with the processing unit or units, or any combination thereof. The objects comprise electrical devices, electrical systems, sensors, hardware devices, hardware systems, environmental devices and systems, energy and energy distribution devices and systems, software systems, software programs, software objects, or combinations thereof. The attributes comprise adjustable attributes associated with the devices, systems, programs and/or objects. In certain embodiments, the sensor(s) is(are) capable of discerning a change in movement, velocity and/or acceleration of ±5%. In other embodiments, the sensor(s) is(are) capable of discerning a change in movement, velocity and/or acceleration of ±10°. In other embodiments, the system further comprising a remote control unit or remote control system in communication with the processing unit to provide remote control of the processing unit and all real and/or virtual objects under the control of the processing unit. In other embodiments, the motion sensor is selected from the group consisting of digital cameras, optical scanners, optical roller ball devices, touch pads, inductive pads, capacitive pads, holographic devices, laser tracking devices, thermal devices, touch or touchless sensors, acoustic devices, and any other device capable of sensing motion, arrays of such devices, and mixtures and combinations thereof. In other embodiments, the objects include environmental controls, lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical or manufacturing plant control systems, computer operating systems and other software systems, remote control systems, mobile devices, electrical systems, sensors, hardware devices, hardware systems, environmental devices and systems, energy and energy distribution devices and systems, software programs or objects or mixtures and combinations thereof.

Embodiments of methods of this disclosure for controlling objects include the step of sensing movement, movement direction, movement velocity, and/or movement acceleration, and/or changes in movement direction, changes in movement velocity, and/or changes in movement acceleration, and/or changes in a rate of a change in direction, changes in a rate of a change in velocity and/or changes in a rate of a change in acceleration within the active zone by one or a plurality of body parts or objects within an active sensing zone of a motion sensor or within active sensing zones of an array of motion sensors. The methods also include the step of producing an output signal or a plurality of output signals from the sensor or sensors and converting the output signal or signals into a command function or a plurality of command functions. The command and control functions comprise at least (1) a scroll function or a plurality of scroll functions, (2) a select function or a plurality of select functions, (3) an attribute function or plurality of attribute functions, (4) an attribute control function or a plurality of attribute control functions, or (5) a simultaneous control function. The simultaneous control function includes (a) a select function or a plurality of select functions and a scroll function or a plurality of scroll functions, (b) a select function or a plurality of select functions and an activate function or a plurality of activate functions, and (c) a select function or a plurality of select functions and an attribute control function or a plurality of attribute control functions. In certain embodiments, the objects comprise electrical devices, electrical systems, sensors, hardware devices, hardware systems, environmental devices and systems, energy and energy distribution devices and systems, software systems, software programs, software objects, or combinations thereof. In other embodiments, the attributes comprise adjustable attributes associated with the devices, systems, programs and/or objects. In other embodiments, the timed hold is brief or the brief cessation of movement causing the attribute to be adjusted to a preset level, causing a selection to be made, causing a scroll function to be implemented, or a combination thereof. In other embodiments, the timed hold is continued causing the attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value or scroll function in a direction of the initial motion until the timed hold is removed. In other embodiments, the motion sensor is selected from the group consisting of sensors of any kind including digital cameras, optical scanners, optical roller ball devices, touch pads, inductive pads, capacitive pads, holographic devices, laser tracking devices, thermal devices, touch or touchless sensors, acoustic devices, and any other device capable of sensing motion or changes in any waveform due to motion or arrays of such devices, and mixtures and combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems and other software systems, remote control systems, sensors, or mixtures and combinations thereof.

The all of these scenarios set forth above are designed to illustrate the control of a large number of devices using properties and/or characteristics of the sensed motion including, without limitation, relative distance of the motion for each object (real like a person in a room using his/her hand as the object for which motion is being sensed or virtual representations of the objects in a virtual or rendered room on a display apparatus), direction of motion, speed of motion, acceleration of motion, changes an any of these properties, rates of changes in any of these properties, or mixtures and combinations thereof to control a single controllable attribute of the object such as lights. However, the systems, apparatuses, and methods of this disclosure are also capable of using motion properties and/or characteristics to control two, three, or more attributes of an object. Additionally, the systems, apparatuses, and methods of this disclosure are also capable of using motion properties and/or characteristics from a plurality of moving objects within a motion sensing zone to control different attributes of a collection of objects. For example, if the lights in the above figures are capable of color as well as brighten, then the motion properties and/or characteristic may be used to simultaneously change color and intensity of the lights or one sensed motion could control intensity, while another sensed motion could control color. For example, if an artist wanted to paint a picture on a computer generated canvas, then motion properties and/or characteristic would allow the artist to control the pixel properties of each pixel on the display using the properties of the sensed motion from one, two, three, etc. sensed motions. Thus, the systems, apparatuses, and methods of this disclosure are capable of converting the motion properties associated with each and every object being controlled based on the instantaneous properties values as the motion traverse the object in real space or virtual space.

The systems, apparatuses and methods of this disclosure activate upon motion being sensed by one or more motion sensors. This sensed motion then activates the systems and apparatuses causing the systems and apparatuses to process the motion and its properties activating a selection object and a plurality of selectable objects. Once activated, the motion properties cause movement of the selection object accordingly, which will cause a pre-selected object or a group of pre-selected objects, to move toward the selection object, where the pre-selected object or the group of pre-selected objects are the selectable object(s) that are most closely aligned with the direction of motion, which may be evidenced by the user feedback units by corresponding motion of the selection object. Another aspect of the systems or apparatuses of this disclosure is that the faster the selection object moves toward the pre-selected object or the group of preselected objects, the faster the pre-selected object or the group of preselected objects move toward the selection object. Another aspect of the systems or apparatuses of this disclosure is that as the pre-selected object or the group of pre-selected objects move toward the selection object, the pre-selected object or the group of pre-selected objects may increase in size, change color, become highlighted, provide other forms of feedback, or a combination thereof. Another aspect of the systems or apparatuses of this disclosure is that movement away from the objects or groups of objects may result in the objects moving away at a greater or accelerated speed from the selection object(s). Another aspect of the systems or apparatuses of this disclosure is that as motion continues, the motion will start to discriminate between members of the group of pre-selected object(s) until the motion results in the selection of a single selectable object or a coupled group of selectable objects. Once the selection object and the target selectable object touch, active areas surrounding the objection touch, a threshold distance between the object is achieved, or a probability of selection exceeds an activation threshold, the target object is selected and non-selected display objects are removed from the display, change color or shape, or fade away or any such attribute so as to recognize them as not selected. The systems or apparatuses of this disclosure may center the selected object in a center of the user feedback unit or center the selected object at or near a location where the motion was first sensed. The selected object may be in a corner of a display—on the side the thumb is on when using a phone, and the next level menu is displayed slightly further away, from the selected object, possibly arcuately, so the next motion is close to the first, usually working the user back and forth in the general area of the center of the display. If the object is an executable object such as taking a photo, turning on a device, etc, then the execution is simultaneous with selection. If the object is a submenu, sublist or list of attributes associated with the selected object, then the submenu members, sublist members or attributes are displayed on the screen in a spaced apart format. The same procedure used to select the selected object is then used to select a member of the submenu, sublist or attribute list. Thus, the interfaces have a gravity like or anti-gravity like action on display objects. As the selection object(s) moves, it attracts an object or objects in alignment with the direction of the selection object's motion pulling those object(s) toward it and may simultaneously or sequentially repel non-selected items away or indicate non-selection in any other manner so as to discriminate between selected and non-selected objects. As motion continues, the pull increases on the object most aligned with the direction of motion, further accelerating the object toward the selection object until they touch or merge or reach a threshold distance determined as an activation threshold. The touch or merge or threshold value being reached causes the processing unit to select and activate the object(s). Additionally, the sensed motion may be one or more motions detected by one or more movements within the active zones of the motion sensor(s) giving rise to multiple sensed motions and multiple command function that may be invoked simultaneously or sequentially. The sensors may be arrayed to form sensor arrays. If the object is an executable object such as taking a photo, turning on a device, etc, then the execution is simultaneous with selection. If the object is a submenu, sublist or list of attributes associated with the selected object, then the submenu members, sublist members or attributes are displayed on the screen is a spaced apart format. The same procedure used to select the selected object is then used to select a member of the submenu, sublist or attribute list. Thus, the interfaces have a gravity like action on display objects. As the selection object moves, it attracts an object or objects in alignment with the direction of the selection object's motion pulling those object toward it. As motion continues, the pull increases on the object most aligned with the direction of motion, further accelerating the object toward the selection object until they touch or merge or reach a threshold distance determined as an activation threshold to make a selection. The touch, merge or threshold event causes the processing unit to select and activate the object.

The sensed motion may result not only in activation of the systems or apparatuses of this disclosure, but may be result in select, attribute control, activation, actuation, scroll or combination thereof.

Different haptic (tactile) or audio or other feedback may be used to indicate different choices to the user, and these may be variable in intensity as motions are made. For example, if the user moving through radial zones different objects may produce different buzzes or sounds, and the intensity or pitch may change while moving in that zone to indicate whether the object is in front of or behind the user.

Compound motions may also be used so as to provide different control function than the motions made separately or sequentially. This includes combination attributes and changes of both state and attribute, such as tilting the device to see graphics, graphics and text or text, along with changing scale based on the state of the objects, while providing other controls simultaneously or independently, such as scrolling, zooming in/out, or selecting while changing state. These features may also be used to control chemicals being added to a vessel, while simultaneously controlling the amount. These features may also be used to change between Windows 8 and Windows 7 with a tilt while moving icons or scrolling through programs at the same time.

Audible or other communication medium may be used to confirm object selection or in conjunction with motion so as to provide desired commands (multimodal) or to provide the same control commands in different ways.

The present systems, apparatuses, and methods may also include artificial intelligence components that learn from user motion characteristics, environment characteristics (e.g., motion sensor types, processing unit types, or other environment properties), controllable object environment, etc. to improve or anticipate object selection responses.

Embodiments of this disclosure further relate to systems for selecting and activating virtual or real objects and their controllable attributes including at least one motion sensor having an active sensing zone, at least one processing unit, at least one power supply unit, and one object or a plurality of objects under the control of the processing units. The sensors, processing units, and power supply units are in electrical communication with each other. The motion sensors sense motion including motion properties within the active zones, generate at least one output signal, and send the output signals to the processing units. The processing units convert the output signals into at least one command function. The command functions include (1) a start function, (2) a scroll function, (3) a select function, (4) an attribute function, (5) an attribute control function, (6) a simultaneous control function including: (7) a select and scroll function, (8) a select, scroll and activate function, (9) a select, scroll, activate, and attribute control function, (10) a select and activate function, (11) a select and attribute control function, (12) a select, active, and attribute control function, or (13) combinations thereof, or (14) combinations thereof. The start functions activate at least one selection or cursor object and a plurality of selectable objects upon first sensing motion by the motion sensors and selectable objects aligned with the motion direction move toward the selection object or become differentiated from non-aligned selectable objects and motion continues until a target selectable object or a plurality of target selectable objects are discriminated from non-target selectable objects resulting in activation of the target object or objects. The motion properties include a touch, a lift off, a direction, a velocity, an acceleration, a change in direction, a change in velocity, a change in acceleration, a rate of change of direction, a rate of change of velocity, a rate of change of acceleration, stops, holds, timed holds, or mixtures and combinations thereof. The objects comprise real-world objects, virtual objects and mixtures or combinations thereof, where the real-world objects include physical, mechanical, electro-mechanical, magnetic, electro-magnetic, electrical, or electronic devices or any other real-world device that can be controlled by a processing unit and the virtual objects include any construct generated in a virtual world or by a computer and displayed by a display device and that are capable of being controlled by a processing unit. The attributes comprise activatable, executable and/or adjustable attributes associated with the objects. The changes in motion properties are changes discernible by the motion sensors and/or the processing units.

In certain embodiments, the start functions further activate the user feedback units and the selection objects and the selectable objects are discernible via the motion sensors in response to movement of an animal, human, robot, robotic system, part or parts thereof, or combinations thereof within the motion sensor active zones. In other embodiments, the system further includes at least on user feedback unit, at least one battery backup unit, communication hardware and software, at least one remote control unit, or mixtures and combinations thereof, where the sensors, processing units, power supply units, the user feedback units, the battery backup units, the remote control units are in electrical communication with each other. In other embodiments, faster motion causes a faster movement of the target object or objects toward the selection object or causes a greater differentiation of the target object or object from the non-target object or objects. In other embodiments, if the activated objects or objects have subobjects and/or attributes associated therewith, then as the objects move toward the selection object, the subobjects and/or attributes appear and become more discernible as object selection becomes more certain. In other embodiments, once the target object or objects have been selected, then further motion within the active zones of the motion sensors causes selectable subobjects or selectable attributes aligned with the motion direction to move towards the selection object(s) or become differentiated from non-aligned selectable subobjects or selectable attributes and motion continues until a target selectable subobject or attribute or a plurality of target selectable objects and/or attributes are discriminated from non-target selectable subobjects and/or attributes resulting in activation of the target subobject, attribute, subobjects, or attributes. In other embodiments, the motion sensor is selected from the group consisting of digital cameras, optical scanners, optical roller ball devices, touch pads, inductive pads, capacitive pads, holographic devices, laser tracking devices, thermal devices, acoustic devices, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, systems, graphics systems, business software systems, word processor systems, internet browsers, accounting systems, military systems, control systems, other software systems, programs, routines, objects and/or elements, remote control systems, or mixtures and combinations thereof. In other embodiments, if the timed hold is brief, then the processing unit causes an attribute to be adjusted to a preset level. In other embodiments, if the timed hold is continued, then the processing unit causes an attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value in a direction of the initial motion until the timed hold is removed. In other embodiments, the motion sensors sense a second motion including second motion properties within the active zones, generate at least one output signal, and send the output signals to the processing units, and the processing units convert the output signals into a confirmation command confirming the selection or at least one second command function for controlling different objects or different object attributes. In other embodiments, the motion sensors sense motions including motion properties of two or more animals, humans, robots, or parts thereof, or objects under the control of humans, animals, and/or robots within the active zones, generate output signals corresponding to the motions, and send the output signals to the processing units, and the processing units convert the output signals into command function or confirmation commands or combinations thereof implemented simultaneously or sequentially, where the start functions activate a plurality of selection or cursor objects and a plurality of selectable objects upon first sensing motion by the motion sensor and selectable objects aligned with the motion directions move toward the selection objects or become differentiated from non-aligned selectable objects and the motions continue until target selectable objects or pluralities of target selectable objects are discriminated from non-target selectable objects resulting in activation of the target objects and the confirmation commands confirm the selections.

Embodiments of this disclosure further relates to methods for controlling objects include sensing motion including motion properties within an active sensing zone of at least one motion sensor, where the motion properties include a direction, a velocity, an acceleration, a change in direction, a change in velocity, a change in acceleration, a rate of change of direction, a rate of change of velocity, a rate of change of acceleration, stops, holds, timed holds, or mixtures and combinations thereof and producing an output signal or a plurality of output signals corresponding to the sensed motion. The methods also include converting the output signal or signals via a processing unit in communication with the motion sensors into a command function or a plurality of command functions. The command functions include (1) a start function, (2) a scroll function, (3) a select function, (4) an attribute function, (5) an attribute control function, (6) a simultaneous control function including: (7) a select and scroll function, (8) a select, scroll and activate function, (9) a select, scroll, activate, and attribute control function, (10) a select and activate function, (11) a select and attribute control function, (12) a select, active, and attribute control function, or (13) combinations thereof, or (14) combinations thereof. The methods also include processing the command function or the command functions simultaneously or sequentially, where the start functions activate at least one selection or cursor object and a plurality of selectable objects upon first sensing motion by the motion sensor and selectable objects aligned with the motion direction move toward the selection object or become differentiated from non-aligned selectable objects and motion continues until a target selectable object or a plurality of target selectable objects are discriminated from non-target selectable objects resulting in activation of the target object or objects, where the motion properties include a touch, a lift off, a direction, a velocity, an acceleration, a change in direction, a change in velocity, a change in acceleration, a rate of change of direction, a rate of change of velocity, a rate of change of acceleration, stops, holds, timed holds, or mixtures and combinations thereof. The objects comprise real-world objects, virtual objects or mixtures and combinations thereof, where the real-world objects include physical, mechanical, electro-mechanical, magnetic, electro-magnetic, electrical, or electronic devices or any other real-world device that can be controlled by a processing unit and the virtual objects include any construct generated in a virtual world or by a computer and displayed by a display device and that are capable of being controlled by a processing unit. The attributes comprise activatable, executable and/or adjustable attributes associated with the objects. The changes in motion properties are changes discernible by the motion sensors and/or the processing units.

In certain embodiments, the motion sensor is selected from the group consisting of digital cameras, optical scanners, optical roller ball devices, touch pads, inductive pads, capacitive pads, holographic devices, laser tracking devices, thermal devices, acoustic devices, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, systems, graphics systems, business software systems, word processor systems, internet browsers, accounting systems, military systems, control systems, other software systems, programs, routines, objects and/or elements, remote control systems, or mixtures and combinations thereof. In other embodiments, if the timed hold is brief, then the processing unit causes an attribute to be adjusted to a preset level. In other embodiments, if the timed hold is continued, then the processing unit causes an attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value in a direction of the initial motion until the timed hold is removed. In other embodiments, the methods include sensing second motion including second motion properties within the active sensing zone of the motion sensors, producing a second output signal or a plurality of second output signals corresponding to the second sensed motion, converting the second output signal or signals via the processing units in communication with the motion sensors into a second command function or a plurality of second command functions, and confirming the selection based on the second output signals, or processing the second command function or the second command functions and moving selectable objects aligned with the second motion direction toward the selection object or become differentiated from non-aligned selectable objects and motion continues until a second target selectable object or a plurality of second target selectable objects are discriminated from non-target second selectable objects resulting in activation of the second target object or objects, where the motion properties include a touch, a lift off, a direction, a velocity, an acceleration, a change in direction, a change in velocity, a change in acceleration, a rate of change of direction, a rate of change of velocity, a rate of change of acceleration, stops, holds, timed holds, or mixtures and combinations thereof. In other embodiments, the methods include sensing motions including motion properties of two or more animals, humans, robots, or parts thereof within the active zones of the motion sensors, producing output signals corresponding to the motions, converting the output signals into command function or confirmation commands or combinations thereof, where the start functions activate a plurality of selection or cursor objects and a plurality of selectable objects upon first sensing motion by the motion sensor and selectable objects aligned with the motion directions move toward the selection objects or become differentiated from non-aligned selectable objects and the motions continue until target selectable objects or pluralities of target selectable objects are discriminated from non-target selectable objects resulting in activation of the target objects and the confirmation commands confirm the selections.

### Suitable Components for Use in the Disclosure

### Motion Sensors

Suitable motion sensors include, without limitation, optical sensors, acoustic sensors, thermal sensors, optoacoustic sensors, wave form sensors, pixel differentiators, or any other sensor or combination of sensors that are capable of sensing movement or changes in movement, or mixtures and combinations thereof. Suitable motion sensing apparatus include, without limitation, motion sensors of any form such as digital cameras, optical scanners, optical roller ball devices, touch pads, inductive pads, capacitive pads, holographic devices, laser tracking devices, thermal devices, electromagnetic field (EMF) sensors, wave form sensors, any other device capable of sensing motion, changes in EMF, changes in a wave form, eye tracking sensors, head tracking sensors, face tracking sensors, or the like or arrays of such devices or mixtures or combinations thereof. The sensors may be digital, analog, or a combination of digital and analog. The motion sensors may be touch pads, touchless pads, touch sensors, touchless sensors, inductive sensors, capacitive sensors, optical sensors, acoustic sensors, thermal sensors, optoacoustic sensors, electromagnetic field (EMF) sensors, strain gauges, accelerometers, pulse or waveform sensor, any other sensor that senses movement or changes in movement, or mixtures and combinations thereof. The sensors may be digital, analog, or a combination of digital and analog or any other type. For camera systems, the systems may sense motion within a zone, area, or volume in front of the lens or a plurality of lens. Optical sensors include any sensor using electromagnetic waves to detect movement or motion within in active zone. The optical sensors may operate in any region of the electromagnetic spectrum including, without limitation, radio frequency (RF), microwave, near infrared (IR), IR, far IR, visible, ultra violet (UV), or mixtures and combinations thereof. Exemplary optical sensors include, without limitation, camera systems, the systems may sense motion within a zone, area or volume in front of the lens. Acoustic sensor may operate over the entire sonic range which includes the human audio range, animal audio ranges, other ranges capable of being sensed by devices, or mixtures and combinations thereof. EMF sensors may be used and operate in any frequency range of the electromagnetic spectrum or any waveform or field sensing device that are capable of discerning motion with a given electromagnetic field (EMF), any other field, or combination thereof. Moreover, LCD screen(s), other screens and/or displays may be incorporated to identify which devices are chosen or the temperature setting, etc. Moreover, the interface may project a virtual control surface and sense motion within the projected image and invoke actions based on the sensed motion. The motion sensor associated with the interfaces of this disclosure may also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform may be used to discern motion and any sensor measuring gravitational, magnetic, electro-magnetic, or electrical changes relating to motion or contact while moving (resistive and capacitive screens) could be used. Of course, the interfaces can include mixtures or combinations of any known or yet to be invented motion sensors. The motion sensors may be used in conjunction with displays, keyboards, touch pads, touchless pads, sensors of any type, or other devices associated with a computer, a notebook computer or a drawing tablet or any mobile or stationary device, and/or device, head worn device, or stationary device.

Suitable motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, MEMS sensors, any other device capable of sensing motion, changes in EMF, changes in wave form, or the like or arrays of such devices or mixtures or combinations thereof. Other motion sensors that sense changes in pressure, in stress and strain (strain gauges), changes in surface coverage measured by sensors that measure surface area or changes in surface are coverage, change in acceleration measured by accelerometers, or any other sensor that measures changes in force, pressure, velocity, volume, gravity, acceleration, any other force sensor or mixtures and combinations thereof.

The motion sensors may also be used in conjunction with displays, keyboards, touch pads, touchless pads, sensors of any type, or other devices associated with a computer, a notebook computer, a drawing tablet, any other mobile or stationary device, VR systems, devices, objects, and/or elements, and/or AR systems, devices, objects, and/or elements. The motion sensors may be optical sensors, acoustic sensors, thermal sensors, optoacoustic sensors, acoustic devices, accelerometers, velocity sensors, waveform sensors, any other sensor that senses movement or changes in movement, or mixtures or combinations thereof. The sensors may be digital, analog or a combination of digital and analog. For camera and/or video systems, the systems may sense motion (kinetic) data and/or biometric data within a zone, area or volume in front of the lens. Optical sensors may operate in any region of the electromagnetic spectrum and may detect any waveform or waveform type including, without limitation, RF, microwave, near IR, IR, far IR, visible, UV or mixtures or combinations thereof. Acoustic sensor may operate over the entire sonic range which includes the human audio range, animal audio ranges, or combinations thereof. EMF sensors may be used and operate in any region of a discernable wavelength or magnitude where motion or biometric data may be discerned. Moreover, LCD screen(s) may be incorporated to identify which devices are chosen or the temperature setting, etc. Moreover, the interface may project a virtual, virtual reality, and/or augmented reality and sense motion within the projected image and invoke actions based on the sensed motion. The motion sensor associated with the interfaces of this disclosure can also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform could be used to discern motion and any sensor measuring gravitational, magnetic, electro-magnetic, or electrical changes relating to motion or contact while moving (resistive and capacitive screens) could be used. Of course, the interfaces can include mixtures or combinations of any known or yet to be invented motion sensors. Exemplary examples of motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, any other device capable of sensing motion, changes in EMF, changes in wave form, or the like or arrays of such devices or mixtures or combinations thereof.

The biometric sensors for use in the present disclosure include, without limitation, finger print scanners, palm print scanners, retinal scanners, optical sensors, capacitive sensors, thermal sensors, electric field sensors (eField or EMF), ultrasound sensors, neural or neurological sensors, piezoelectric sensors, other type of biometric sensors, or mixtures and combinations thereof. These sensors are capable of capturing biometric data including external and/or internal body part shapes, body part features, body part textures, body part patterns, relative spacing between body parts, and/or any other body part attribute.

The biokinetic sensors for use in the present disclosure include, without limitation, any motion sensor or biometric sensor that is capable of acquiring both biometric data and motion data simultaneously, sequentially, periodically, and/or intermittently.

### Other Input Devices

Suitable input devices for use in this disclosure include, without limitation, keyboard devices, pointing devices such as mouse pointing devices or other similar pointing devices, joystick devices, light pen devices, trackball devices, scanner devices, graphic tablet devices, audio input devices such as microphone devices or other similar audio input devices, magnetic ink card reader (MICR) devices, game pad devices, optical input devices such as webcam devices, camera devices, video capture devices, digital camera devices, or other similar optical input devices, optical character reader (OCR) devices, bar code reader devices, optical mark reader (OMR) devices, touchpad devices, electronic whiteboard devices, magnetic tape drive devices, or any combination thereof.

### Output Devices or User Feedback Units

Suitable output devices for use in this disclosure include, without limitation, visual output devices such as LED display devices, plasma display devices, LCD display devices, CRT display devices, or other similar display devices, printing devices, plotting devices, projector devices, LCD projection panel devices, audio output devices such as speakers, head phones, or any combination thereof.

Suitable user feedback units include, without limitation, cathode ray tubes, liquid crystal displays, light emitting diode displays, organic light emitting diode displays, plasma displays, touch screens, touch sensitive input/output devices, audio input/output devices, audio-visual input/output devices, holographic displays and environments, keyboard input devices, mouse input devices, optical input devices, and any other input and/or output device that permits a user to receive user intended inputs and generated output signals, and/or create input signals.

### Controllable Objects

Suitable physical mechanical, electro-mechanical, magnetic, electro-magnetic, electrical, or electronic devices, hardware devices, appliances, biometric devices, automotive devices, VR objects, AR objects, MR objects, and/or any other real world device and/or virtual object that may be controlled by a processing unit include, without limitation, any electrical and/or hardware device or appliance or VR object that may or may not have attributes, all of which may be controlled by a switch, a joy stick, a stick controller, other similar type controller, and/or software programs or objects. Exemplary examples of such attributes include, without limitation, ON, OFF, intensity and/or amplitude, impedance, capacitance, inductance, software attributes, lists, submenus, layers, sublayers, other leveling formats associated with software programs, objects, haptics, any other controllable electrical and/or electro-mechanical function and/or attribute of the device and/or mixtures or combinations thereof. Exemplary examples of devices include, without limitation, environmental controls, building systems and controls, lighting devices such as indoor and/or outdoor lights or light fixtures, cameras, ovens (conventional, convection, microwave, and/or etc.), dishwashers, stoves, sound systems, mobile devices, display systems (TVs, VCRs, DVDs, cable boxes, satellite boxes, and/or etc.), alarm systems, control systems, air conditioning systems (air conditions and heaters), energy management systems, medical devices, vehicles, robots, robotic control systems, UAVs, equipment and machinery control systems, hot and cold water supply devices, air conditioning system, heating systems, fuel delivery systems, energy management systems, product delivery systems, ventilation systems, air handling systems, computers and computer systems, chemical plant control systems, manufacturing plant control systems, computer operating systems and other software systems, programs, routines, objects, and/or elements, remote control systems, or the like virtual and augmented reality systems, holograms, and/or mixtures or combinations thereof.

### Software Systems

Suitable software systems, software products, and/or software objects that are amenable to control by the interface of this disclosure include, without limitation, any analog or digital processing unit or units having single or a plurality of software products installed thereon and where each software product has one or more adjustable attributes associated therewith, or singular software programs or systems with one or more adjustable attributes, menus, lists, or other functions, attributes, and/or characteristics, and/or display outputs. Exemplary examples of such software products include, without limitation, operating systems, graphics systems, business software systems, word processor systems, business systems, online merchandising, online merchandising systems, purchasing and business transaction systems, databases, software programs and applications, internet browsers, accounting systems, military systems, control systems, VR, AR, MR, and/or XR systems or the like, or mixtures or combinations thereof. Software objects generally refer to all components within a software system or product that are controllable by at least one processing unit.

### Processing Units

Suitable processing units for use in the present disclosure include, without limitation, digital processing units (DPUs), analog processing units (APUs), Field Programmable Gate Arrays (FPGAs), any other technology that may receive motion sensor output and generate command and/or control functions for objects under the control of the processing unit, and/or mixtures and combinations thereof.

Suitable digital processing units (DPUs) include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Ericsson, HP, Samsung, Hitachi, NRC, Applied Materials, AMD, Cyrix, Sun Microsystem, Philips, National Semiconductor, Qualcomm, or any other manufacture of microprocessors or microcontrollers, and/or mixtures or combinations thereof.

Suitable analog processing units (APUs) include, without limitation, any analog processing unit capable of accepting input from a plurality of devices and converting at least some of the input into output designed to control attributes of one or more of the devices. Such analog devices are available from manufacturers such as Analog Devices Inc.

Suitable motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, particles sensors, any other device capable of sensing motion, changes in EMF, changes in wave form, or the like or arrays of such devices or mixtures or combinations thereof.

Suitable smart mobile devices include, without limitation, smart phones, tablets, notebooks, desktops, watches, wearable smart devices, or any other type of mobile smart device. Exemplary smart phone, table, notebook, watches, wearable smart devices, or other similar device manufacturers include, without limitation, ACER, ALCATEL, ALLVIEW, AMAZON, AMOI, APPLE, ARCHOS, ASUS, AT&T, BENEFON, BENQ, BENQ-SIEMENS, BIRD, BLACKBERRY, BLU, BOSCH, BQ, CASIO, CAT, CELKON, CHEA, COOLPAD, DELL, EMPORIA, ENERGIZER, ERICSSON, ETEN, FUJITSU SIEMENS, GARMIN-ASUS, GIGABYTE, GIONEE, GOOGLE, HAIER, HP, HTC, HUAWEI, I-MATE, I-MOBILE, ICEMOBILE, INNOSTREAM, INQ, INTEX, JOLLA, KARBONN, KYOCERA, LAVA, LEECO, LENOVO, LG, MAXON, MAXWEST, MEIZU, MICROMAX, MICROSOFT, MITAC, MITSUBISHI, MODU, MOTOROLA, MWG, NEC, NEONODE, NIU, NOKIA, NVIDIA, O2, ONEPLUS, OPPO, ORANGE, PALM, PANASONIC, PANTECH, PARLA, PHILIPS, PLUM, POSH, PRESTIGIO, QMOBILE, QTEK, QUALCOM, SAGEM, SAMSUNG, SENDO, SEWON, SHARP, SIEMENS, SONIM, SONY, SONY ERICSSON, SPICE, T-MOBILE, TEL.ME., TELIT, THURAYA, TOSHIBA, UNNECTO, VERTU, VERYKOOL, VIVO, VK MOBILE, VODAFONE, WIKO, WND, XCUTE, XIAOMI, XOLO, YEZZ, YOTA, YU, and ZTE. It should be recognized that all of these mobile smart devices including a processing unit (often times more than one), memory, communication hardware and software, a rechargeable power supply, and at least one human cognizable output device, where the output device may to be audio, visual and/or audio visual.

Suitable non-mobile, computer and server devices include, without limitation, such devices manufactured by @Xi Computer Corporation, @Xi Computer, ABS Computer Technologies (Parent: Newegg), Acer, Gateway, Packard Bell, ADEK Industrial Computers, Advent, Amiga, Inc., A-EON Technology, ACube Systems Srl, Hyperion Entertainment, Agilent, Aigo, AMD, Alcutia, Alienware (Parent: Dell), AMAX Information Technologies, Ankermann, AORUS, AOpen, Apple, Arnouse Digital Devices Corp (ADDC), ASRock, Asus, AVADirect, AXIOO International, BenQ, Biostar, BOXX Technologies, Inc., Chassis Plans, Chillblast, Chip PC, Clevo, Sager Notebook Computers, Cray, Crystal Group, Cybernet Computer Inc., Compal, Cooler Master, CyberPower PC, Cybertron PC, Dell, Wyse Technology, DFI, Digital Storm, Doel (computer), Elitegroup Computer Systems (ECS), Evans & Sutherland, Everex, EVGA, Falcon Northwest, FIC, Fujitsu, Fusion Red, Foxconn, Founder Technology, Getac, Gigabyte, Gradiente, Groupe Bull, Grundig (Parent: Arçelik), Hasec, Hewlett-Packard (HP), Compaq, Hitachi, HTC, Hyundai, IBM, IBuyPower, Intel, Inventec, In-Win, Ironside, Itautec, IGEL, Jetta International, Kohjinsha, Kontron AG, LanFirePC, Lanix, Lanner Electronics, LanSlide Gaming PCs, Lenovo, Medion, LG, LiteOn, Maingear, MDG Computers, Meebox, Mesh Computers, Micron, Microsoft, Micro-Star International (MSI), Micro Center, MiTAC, Motion Computing, Motorola, NComputing, NCR, NEC, NUDT, NVIDIA, NZXT, Olidata, Olivetti, Oracle, Origin PC, Panasonic, Positivo Informática, Psychsoftpc, Puget Systems, Quanta Computer, RCA, Razer, RoseWill, Samsung, Sapphire Technology, Sharp Corporation, Shuttle, SGI, Siragon, Sony, StealthMachines, Supermicro, Systemax, System76, T-Platforms, TabletKiosk, Tadpole Computer, Tatung, Toshiba, Tyan, Unisys, V3 Gaming PC, Velocity Micro, Overdrive PC, Vestel, Venom, VIA Technologies, ViewSonic, Viglen, Virus Computers Inc., Vizio, VT Miltope, Wistron, Wortmann, Xidax, Zelybron, Zombie PC, and Zoostorm, and Zotac. It should be recognized that all of these computer and services including at least one processing unit (often times many processing units), memory, storage devices, communication hardware and software, a power supply, and at least one human cognizable output device, where the output device may to be audio, visual and/or audio visual. It should be recognized that these systems may be in communication with processing units of vehicles (land, air or sea, manned or unmanned) or integrated into the processing units of vehicles (land, air or sea, manned or unmanned).

Suitable biometric measurements include, without limitation, external and internal organ structure, placement, relative placement, gaps between body parts such as gaps between fingers and toes held in a specific orientation, organ shape, size, texture, coloring, color patterns, etc., circulatory system (veins, arteries, capillaries, etc.) shapes, sizes, structures, patterns, etc., any other biometric measure, or mixtures and combinations thereof.

Suitable kinetic measurements include, without limitation, (a) body movements characteristics—how the body moves generally or moves according to a specific set or pattern of movements, (b) body part movement characteristics—how the body part moves generally or moves according to a specific set or pattern of movements, (c) breathing patterns and/or changes in breathing patterns, (d) skin temperature distributions and/or changes in the temperature distribution over time, (e) blood flow patterns and/or changes in blood flow patterns, (f) skin characteristics such as texture, coloring, etc., and/or changes in skin characteristics, (g) body, body part, organ (internal and/or external) movements over short, medium, long, and/or very long time frames (short time frames range between 1 nanosecond and 1 microsecond, medium time frames range between 1 microsecond and 1 millisecond, and long time frames range between 1 millisecond and 1 second) such as eye flutters, skin fluctuations, facial tremors, hand tremors, rapid eye movement, other types of rapid body part movements, or combinations thereof, (h) movement patterns associated with one or more body parts and/or movement patterns of one body part relative to other body parts, (i) movement trajectories associated with one or more body parts and/or movement trajectories of one body part relative to other body parts either dynamically or associated with a predetermined, predefined, or mirrored set of movements, (j) blob data fluctuations associated with one or more body parts and/or movement patterns or trajectories of one body part relative to other body parts either dynamically or associated with a predetermined, predefined, or mirrored set of movements, (k) any other kinetic movements of the body, body parts, organs (internal or external), etc., (1) any movement of an object under control of a user, and (m) mixtures or combinations thereof.

Suitable biokinetic measurements include, without limitation, any combination of biometric measurements and kinetic measurements and biokinetic measurements.

### Predictive Training Methodology

The inventors have found that predictive virtual training systems, apparatuses, interfaces, and methods for implementing them may be constructed including one or more processing units, one or more motion sensing devices or motion sensors, optionally one or more non-motion sensors, one or more input devices, and one or more output devices such as one or more display devices, wherein the processing unit includes a virtual training program and is configured to (a) output the training program in response to user input data sensed by the sensors or received from the input devices, (b) collect user interaction data while performing the virtual training program, and (c) modify, alter, change, augment, update, enhance, reformat, restructure, and/or redesign the virtual training program to better tailor the virtual training program for each user, for each user, type and/or for all users.

### Detailed Description of Drawings of the Disclosure

### A Facility Having a Rectangular Room With a 360 Degree Image Acquisition Subsystem

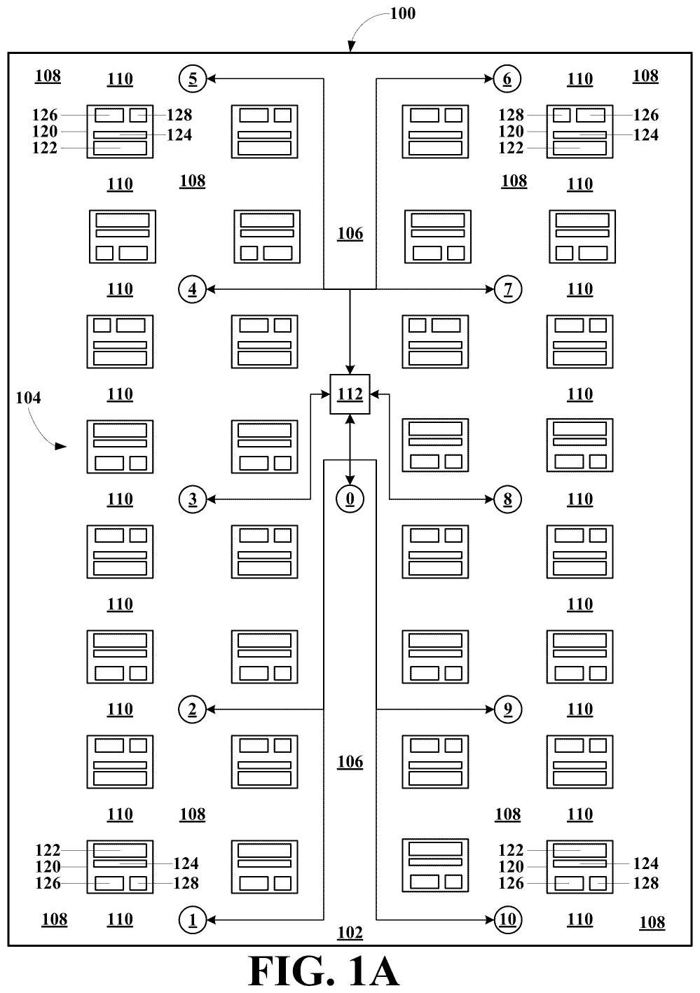

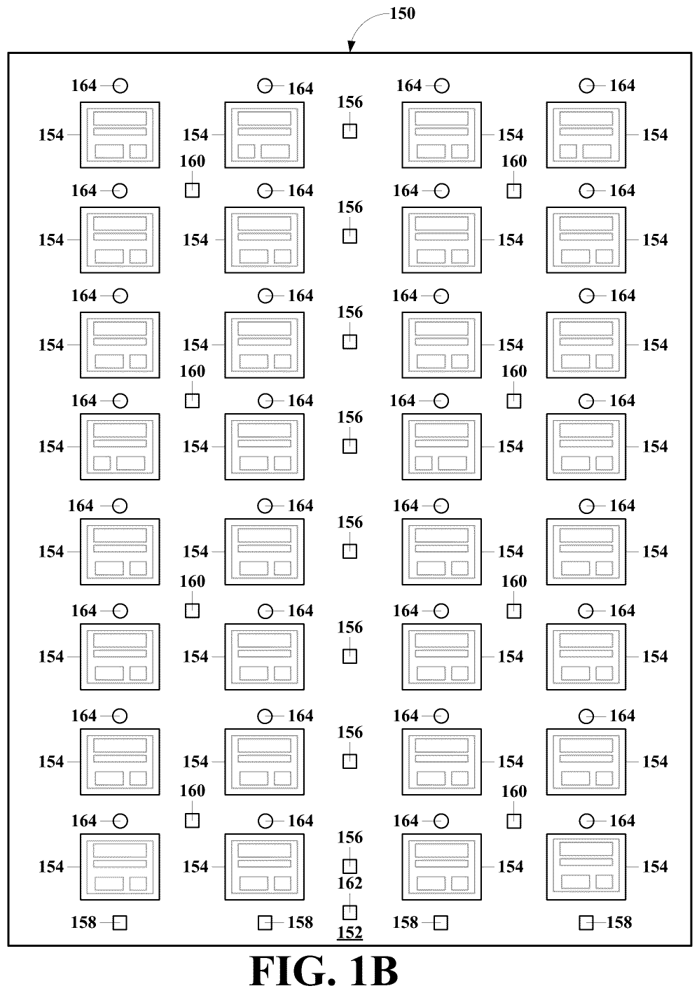

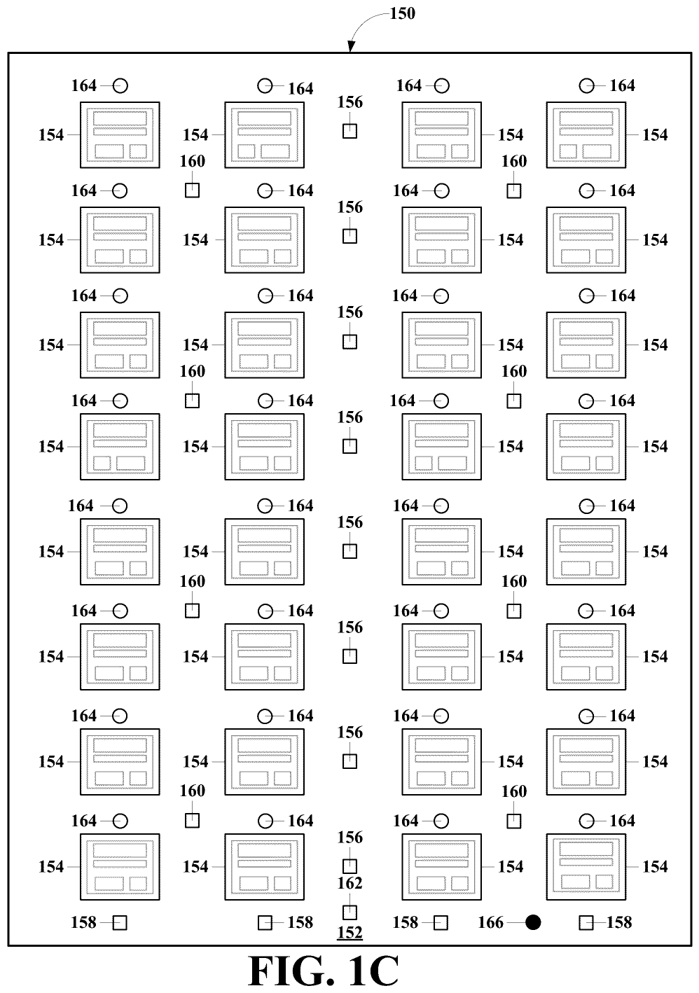

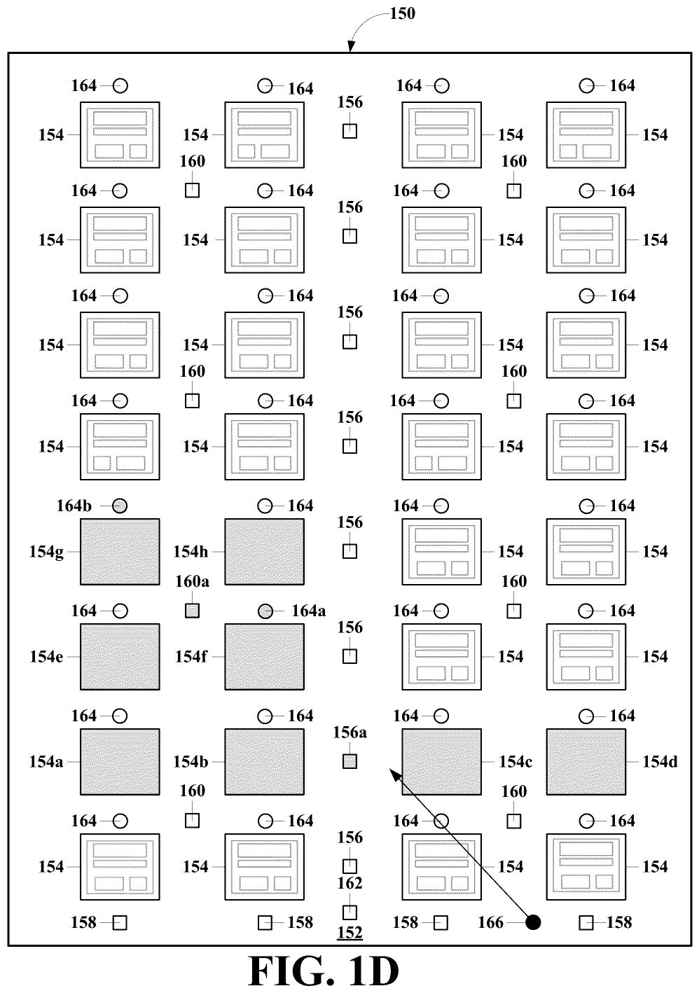

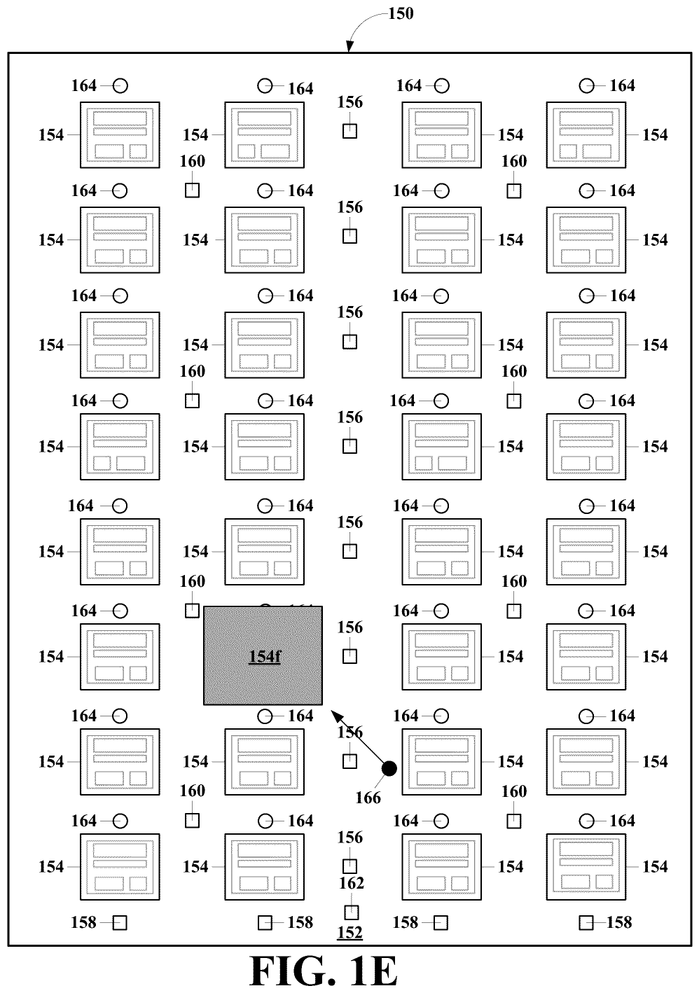

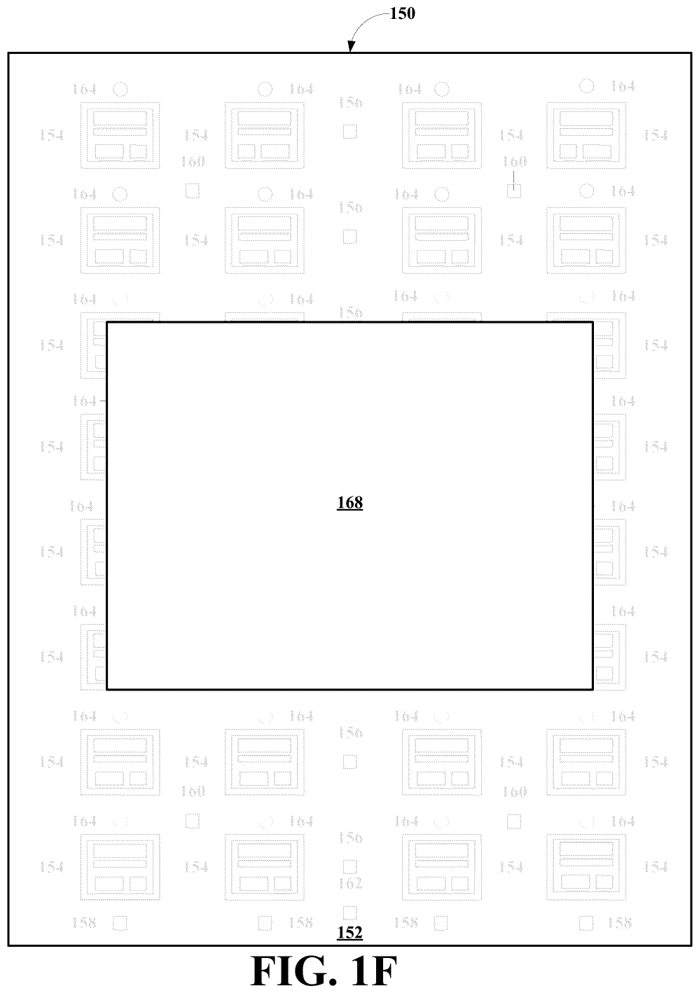

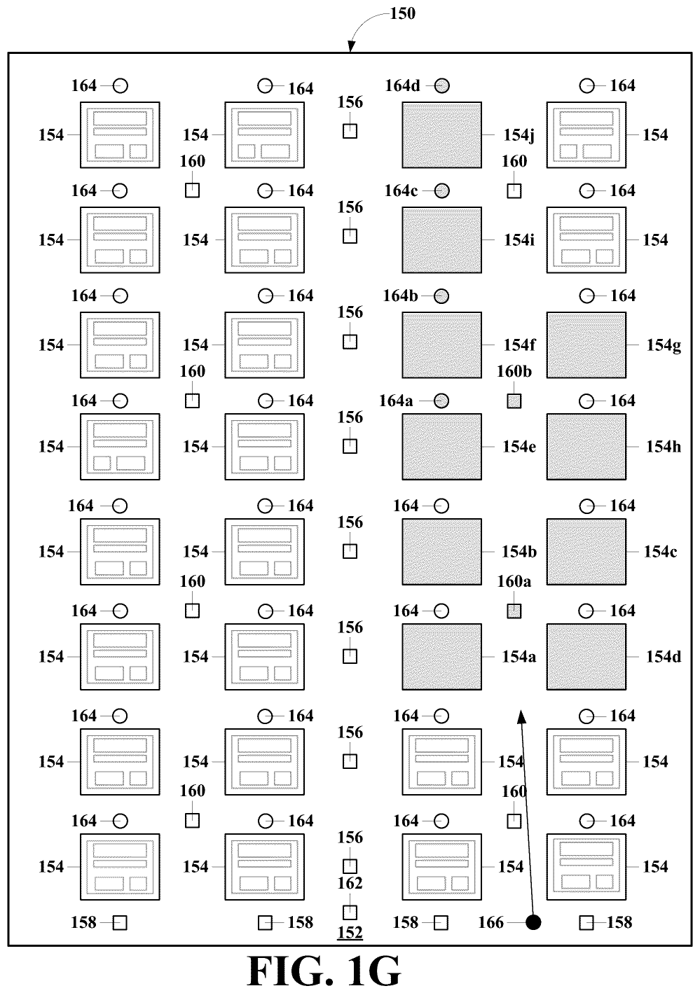

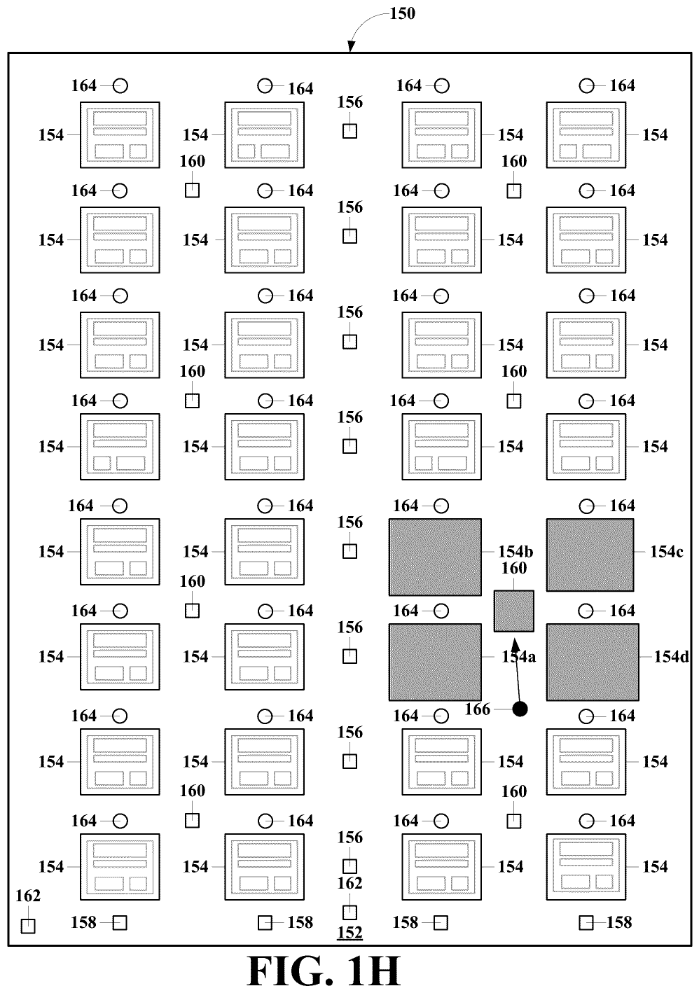

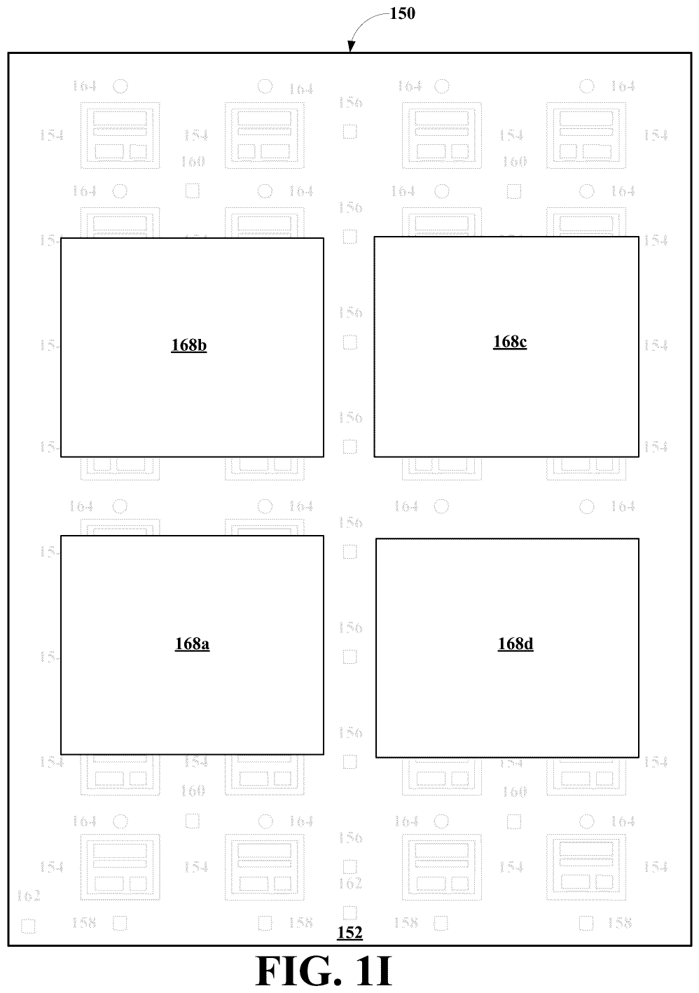

Referring now to FIG. 1A, an embodiment of a facility, generally 100, shown to include a room 102 including a plurality of workstations 120 configured in a matrix type pattern 104 with a central top-bottom isle 106, four top-bottom isles 108, and nine left-right isles 110.

Each of the workstations 120 includes a computer 122 having a display device 124, a keyboard 126, and a mouse 128. The computer 122 may also include other input and output devices such as, voice recognition devices, joy sticks, eye tracking devices, cameras, head tracking devices, gloves, speakers, tactile device, other user discernible output device and any other input or output device, memory, a processing unit, an operating system or structure, communication hardware and software, or other features and/or devices.

The room 102 also includes a 360 degree image acquisition subsystem 112 including a plurality of 360 degree cameras 0-10. Of course, it should be recognized that the 360 degree image acquisition subsystem 112 may include a single 360 camera or a combination of 360 cameras and directional cameras, i.e., cameras designed to capture images within the viewing field of the directional cameras.

Referring now to FIG. 1B, an embodiment of an interactive environment of the facility, generally 150, generated from facility data captured by the 360 degree image acquisition system 112 of FIG. 1A. The interactive environment 150 comprises a combined image sequence from the 360 cameras 0-10, of course, the capture image sequence would also capture people entering, leaving, walking around, and working at workstations 120. While the human activity is not of particular relevance here except for the work performed on the workstations 120, the apparatuses/systems may be used to identify the people and track the people for other uses.

The interactive environment 150 is displayed on a display window 152 of the display device 124. The window 152 includes workstation activation objects 154 associated with each workstation 120. The window 152 also includes row activation objects 156, column activation objects 158, group activation objects 160, and an all activation object 162. A use may activate one, some, or all of the workstation activation objects using motion, gesture, and/or hard selection protocols. The window 152 also includes a plurality of information hot spot activation objects 164. A user may activate one, some, or all of the hot spot activation objects 164 using motion, gesture, and/or hard selection protocols. Of course, a 360 degree image capturing subsystem 112 may be associated with any facility, real world environment, and/or computer generated (CG) environment including only virtual (imaginary items) CG items, real world CG items, or mixture of virtual (imaginary items) CG items, real world CG items.

### Selection of a Single Workstation Activation Object

Referring now to FIGS. 1C-F, an illustration of a motion-based selection of a single workstation activation object.

Looking at FIG. 1C, the apparatuses/systems may detect motion on a touch screen, if the display device is a touch screen, or from a pointer device, a camera, a tracking device resulting in a selection object 166 being displayed in the window 152, e.g., at a bottom right-hand location of the window 152. Of course, the selection object 166 need not actually appear and the apparatus/system may just respond to the detected motion.

Looking at FIG. 1D, the apparatus/system detects motion of the selection object 166 in a diagonal direction resulting in all objects that are possible objects that could be selected based on the direction of motion being highlighted in light grey including one row activation object 156a resulting in the highlighting of the row workstation activation objects 154a-d, one group activation object 160a resulting in the highlighting of the group workstations activation objects 154e-h, two workstation activation objects 154f and 154g, and two hot spot objects 164a and 164b.

Looking at FIG. 1E, the apparatus/system detects further motion of the selection object 166 towards the workstation activation object 154f, which the apparatus/system determines from the further motion is the object the user intended to activate with a certainty greater than 50% and the selection is shown by the workstation activation object 154f being further darkened and enlarged. Of course, the selection may also be confirmed by the apparatus/system based on a secondary input such as voice, touch on a separate tactile device, eye gaze, head node, or other confirmatory detected input.

Looking at FIG. 1F, once the selection was made and/or made and confirmed, the workstation activation object 154f becomes active as a viewable window 168 within the window 152. The viewable window 168 streams the information and data coming from the display device 124 of the workstation 120 of the facility 100 associated with the selected workstation activation object 154f. Additionally, all non-selected objects are faded to a light grey, but may also be faded out completely.

### Selection of a Group Workstation Activation Object

Referring now to FIGS. 1G-I, an illustration of a motion-based selection of a group activation object.

Looking at FIG. 1G, the apparatus/system detects motion of the selection object 166 in a substantially vertical direction resulting in all objects possible of being selected based on the direction of motion being highlighted in light grey including two group activation objects 160a&b resulting in highlighting of the workstation group 154a-d and 154e-h, four individual workstation activation objects 154e, 154f, 154i, and 154j, and four hot spot objects 164-d.

Looking at FIG. 1H, the apparatus/system detects further motion of the selection object 166 towards the group activation object 160a, which the apparatus/system determines from the further motion is the object the user intended to activate with a certainty greater than 50% and the selection is shown by the group activation object 160a and the workstation activation objects 154a-d being further darkened and enlarged. Of course, the selection may also be confirmed by the apparatus/system based on a secondary input such as voice, touch on a separate tactile device, eye gaze, head node, or other confirmatory detected input.

Looking at FIG. 1I, once the selection was made and/or made and confirmed, the workstation activation objects 154a-d becomes active as a viewable window 168a-d within the window 152. The viewable windows 168a-d stream the information and data coming from the display devices 124 of the workstations 120 of the facility 100 associated with the selected workstation activation objects 154a-d. Additionally, all non-selected objects are faded to a light grey, but may also be faded out completely.

### A Facility Having a Circular Room With a 360 Degree Image Acquisition Subsystem

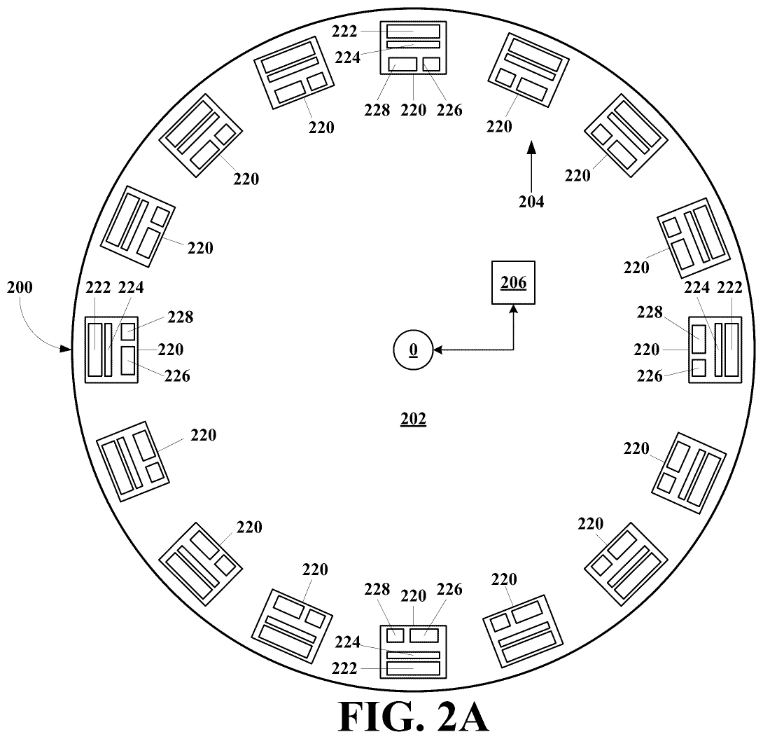

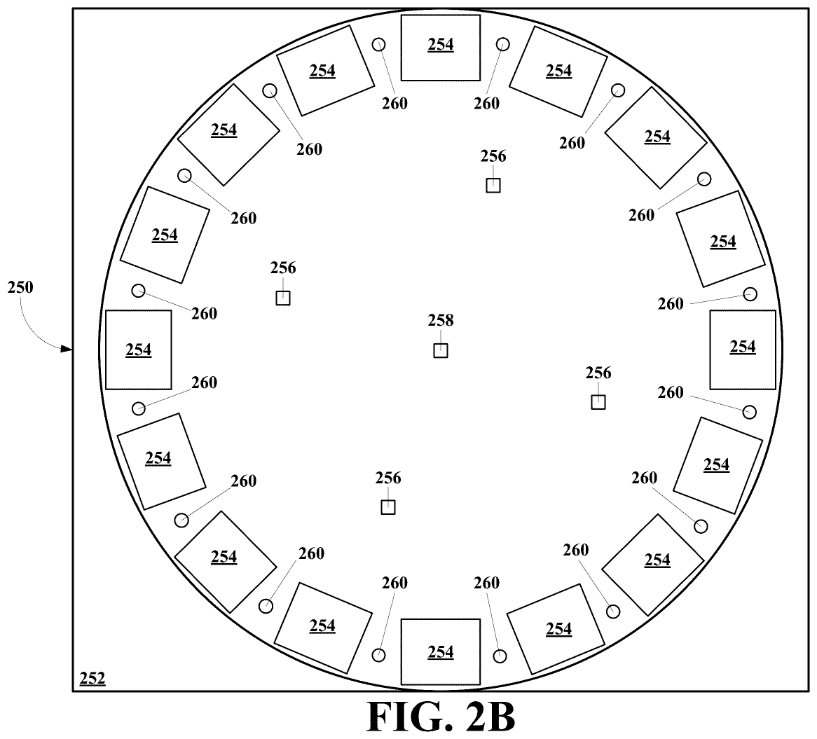

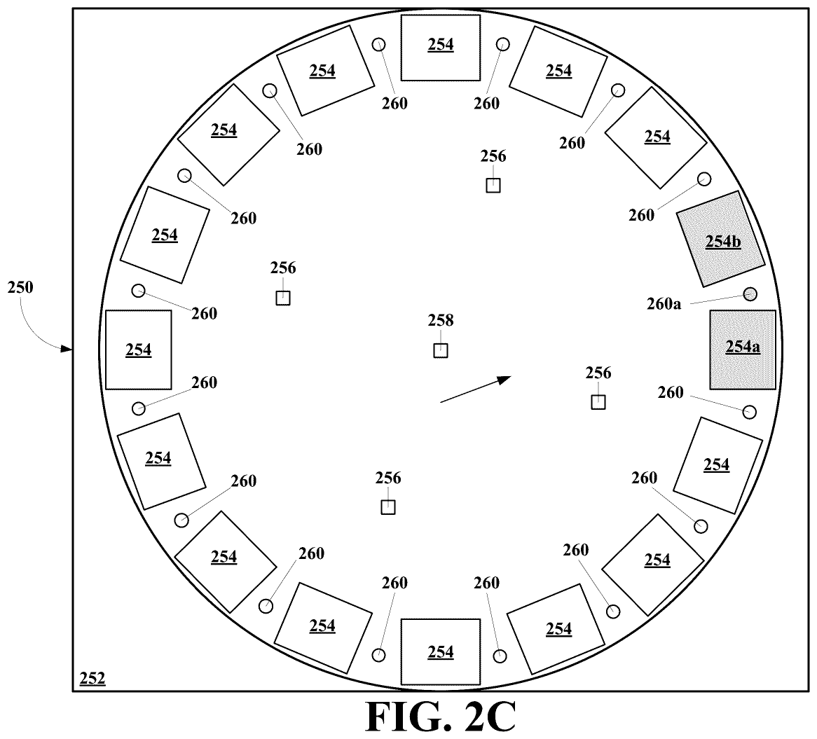

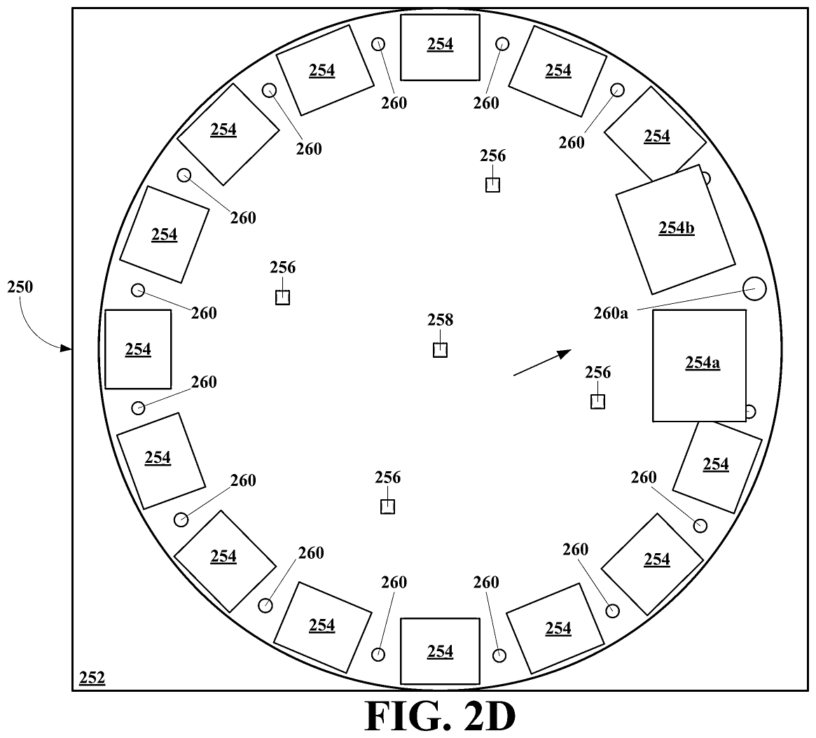

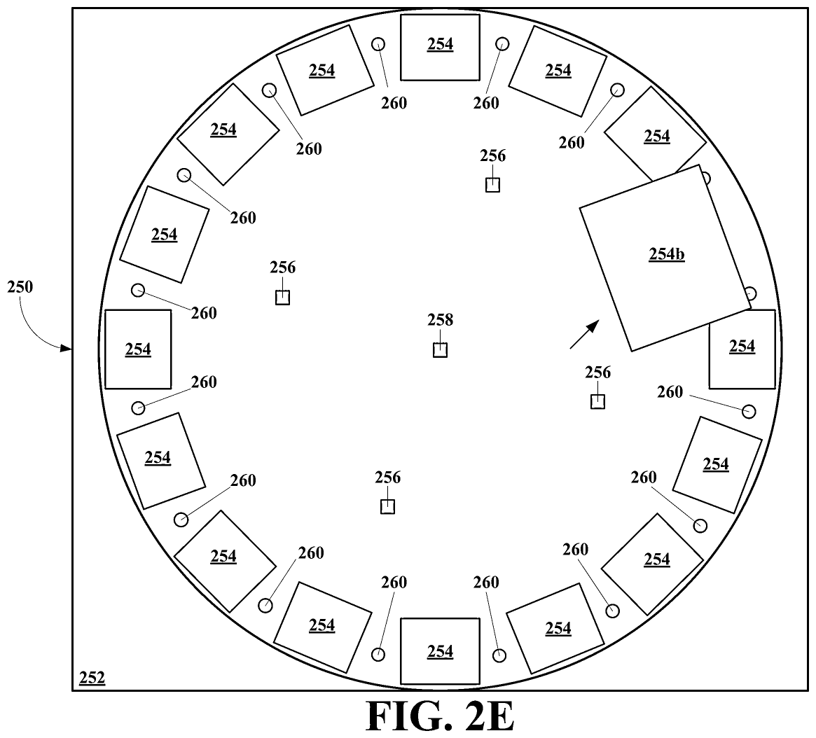

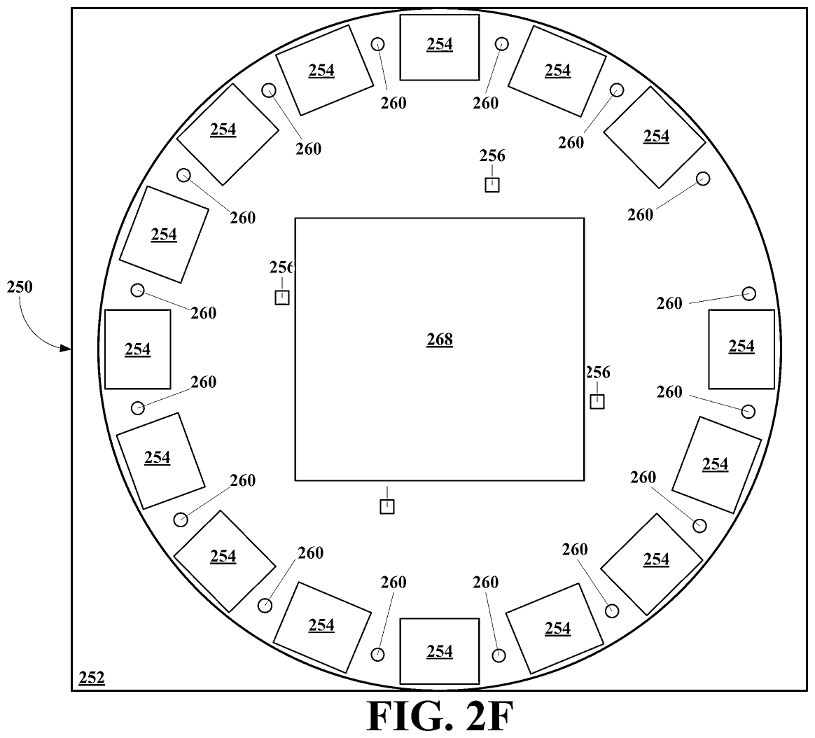

Referring now to FIG. 2A, an embodiment of a facility, generally 200, shown to include a circular room 202 including a plurality of workstations 220 configured in a circular pattern 204 with the circular room 202.

Each of the workstations 220 includes a computer 222 having a display device 224, a keyboard 226, and a mouse 228. The computer 222 may also include other input and output devices such as, voice recognition devices, joy sticks, eye tracking devices, cameras, head tracking devices, gloves, speakers, tactile device, other user discernible output device and any other input or output device, memory, a processing unit, an operating system or structure, communication hardware and software, or other features and/or devices.

The room 202 also includes a 360 degree image acquisition subsystem 206 including a 360 degree cameras 0. Of course, it should be recognized that the 360 degree image acquisition subsystem 206 may include a plurality of 360 cameras or a combination of 360 cameras and directional cameras, i.e., cameras designed to capture images within the viewing field of the directional cameras.

Referring now to FIG. 2B, an embodiment of an interactive environment of the facility, generally 250, generated from facility data captured by the 360 degree image acquisition system 112 of FIG. 2A. The interactive environment 250 comprises an image sequence from the 360 camera 0, of course, the captured image sequence would also capture people entering, leaving, walking around, and working at workstations 220. While the human activity is not of particular relevance here except for the work performed on the workstations 220, the apparatuses/systems may be used to identify the people and track the people for other uses.

The interactive environment 250 is displayed on a display window 252 of the display device 224. The window 252 includes workstation activation objects 254 associated with each workstation 220. The window 252 also includes sector group workstation activation objects 256, and an all workstation activation object 258. A user may activate one, some, or all of the objects using motion, gesture, and/or hard selection protocols. The window 252 also includes a plurality of hot spot activation objects 260. A user may activate one, some, or all of the hot spot activation objects 260 using motion, gesture, and/or hard selection protocols. Of course, a 360 degree image capturing subsystem 206 may be associated with any facility, real world environment, and/or computer generated (CG) environment including only virtual (imaginary items) CG items, real world CG items, or mixture of virtual (imaginary items) CG items, real world CG items.

### Selection of a Single Workstation Activation Object

Referring now to FIGS. 2C-F, an illustration of a motion-based selection of a single workstation activation object.

Looking at FIG. 2C, the apparatuses/systems may detect motion in a cast by northeast direction resulting in all activation objects possible of being selected becoming highlighted in light grey including two workstation activation objects 254a and 254b and a hot spot activation object 260a.

Looking at FIG. 2D, the apparatus/system detects further motion towards the workstation activation objects 254a&b and the hot spot activation object 260a, which results in the workstation activation objects 254a&b and the hot spot activation object 260a becoming enlarged and darkened.

Looking at FIG. 2E, the apparatus/system detects still further motion towards the workstation activation objects 254b. The apparatus/system determines from the still further motion that the user intended to activate the workstation activation object 254b with a certainty greater than 50% and the selection is shown by the workstation activation object 254b being further darkened and enlarged. Of course, the selection may also be confirmed by the apparatus/system based on a secondary input such as voice, touch on a separate tactile device, eye gaze, head node, or other confirmatory detected input.

Looking at FIG. 2F, once the selection is made and/or made and confirmed, the workstation activation object 254b becomes active as a viewable window 268 within the window 252. The viewable window 268 streams the information and data coming from the display devices 224 of the workstations 220 of the facility 200 associated with the selected workstation activation object 254d. Additionally, all non-selected objects are faded to a light grey, but may also be faded out completely.

### A Facility Having a Circular Room With a 360 Degree Image Acquisition Subsystem

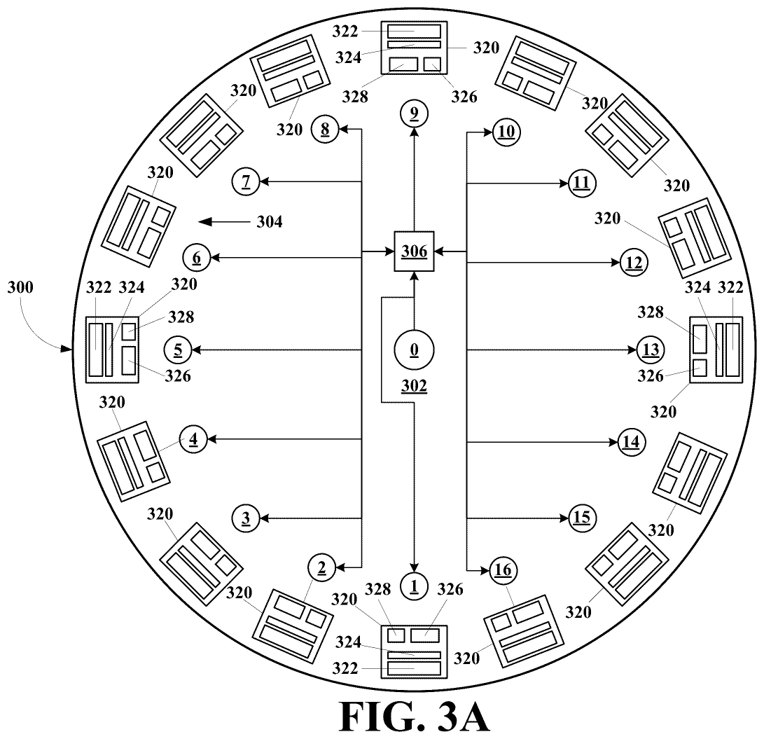

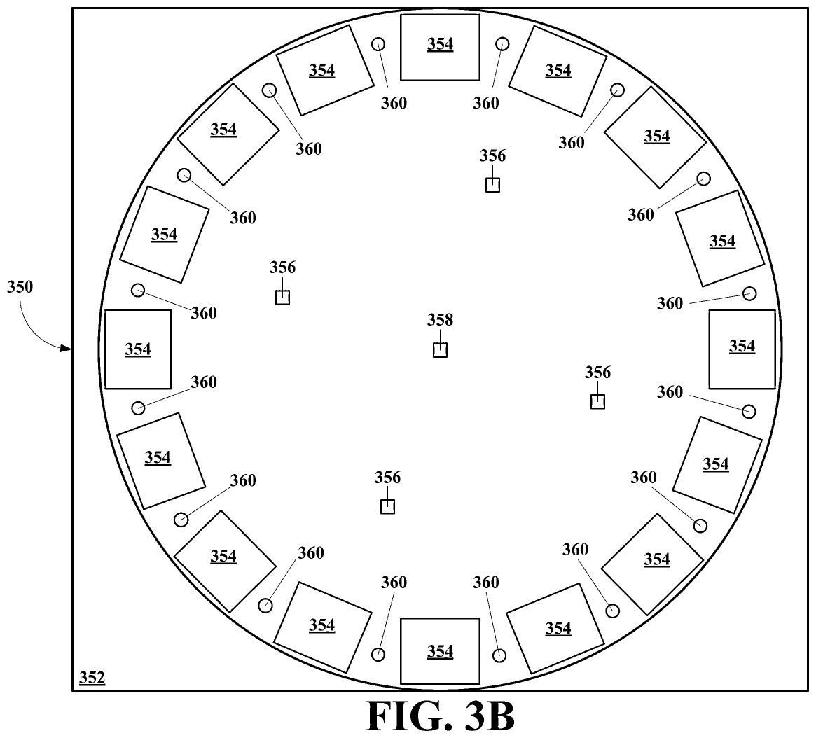

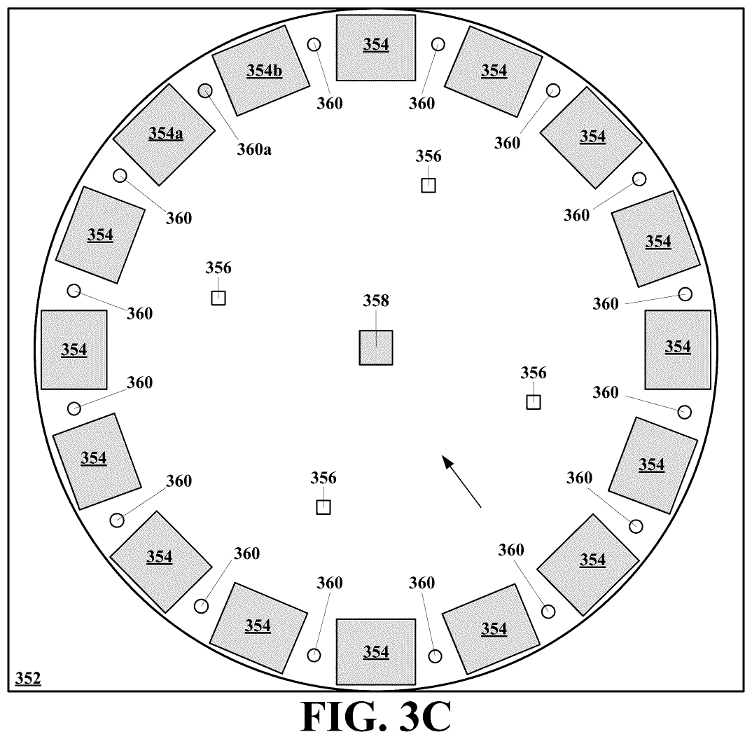

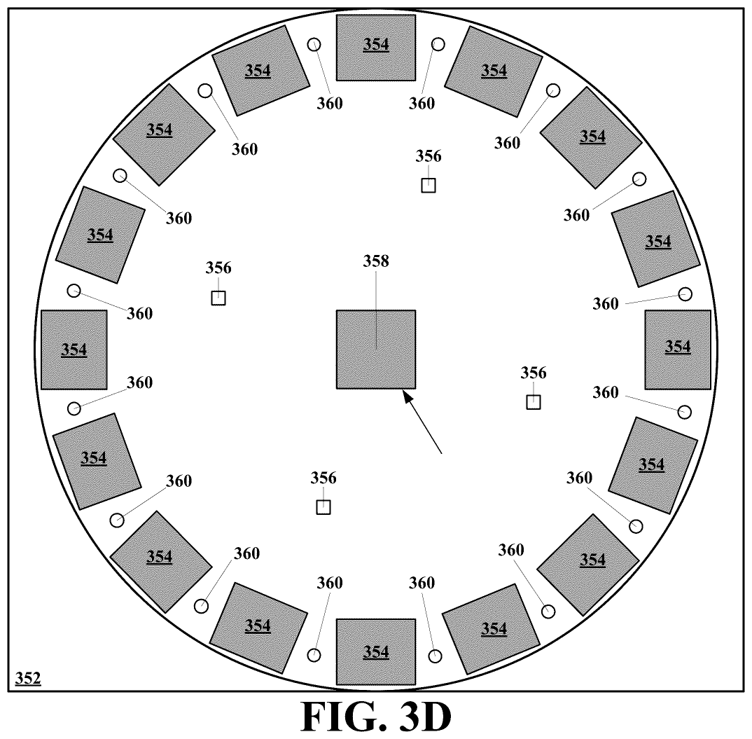

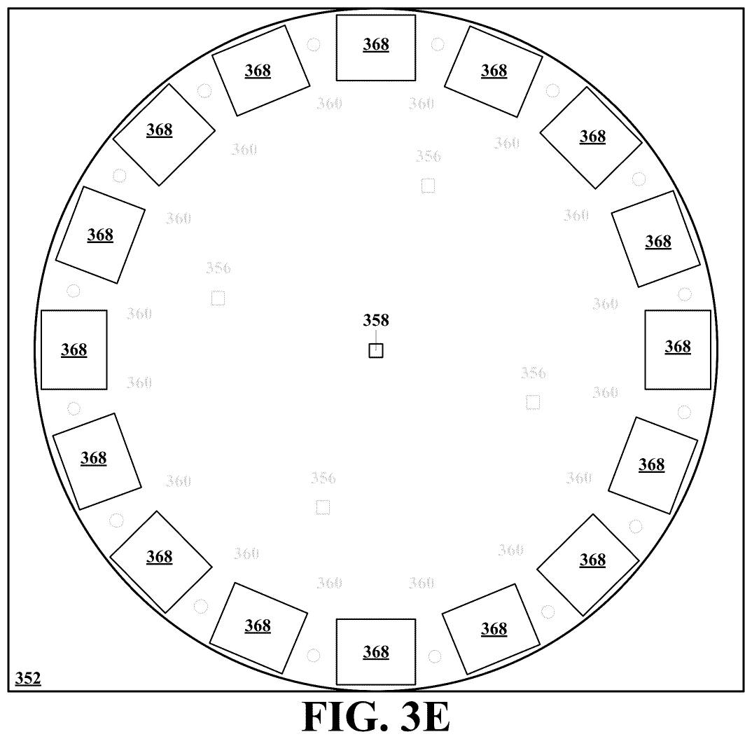

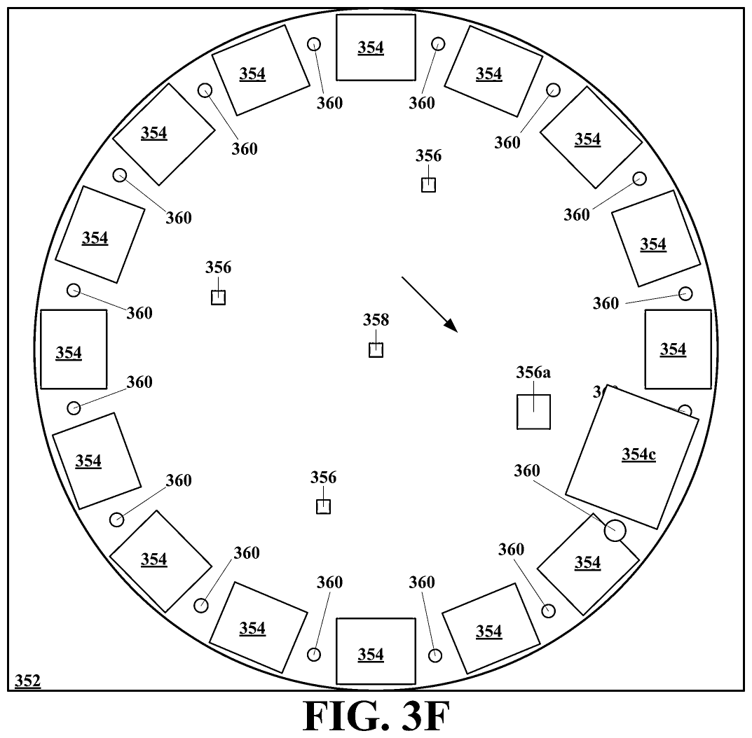

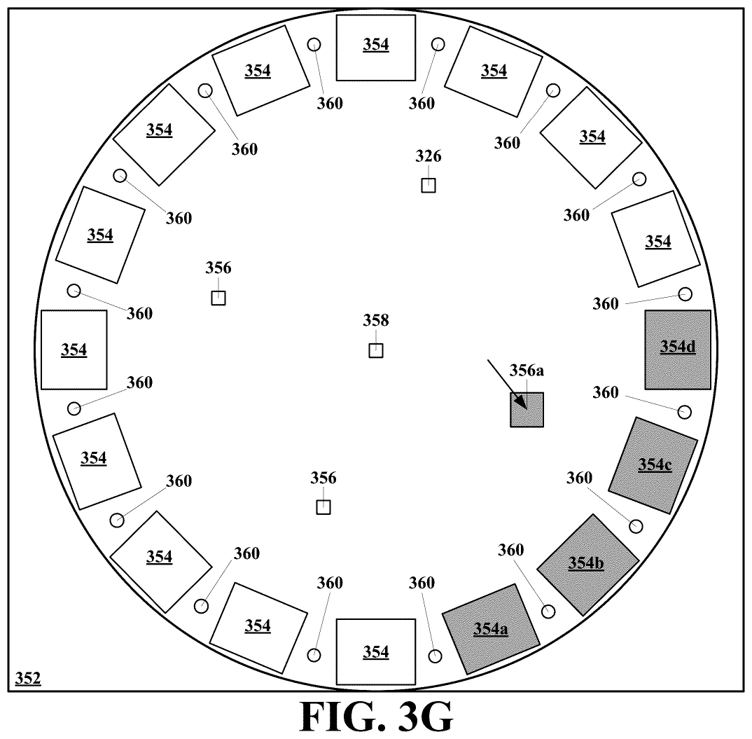

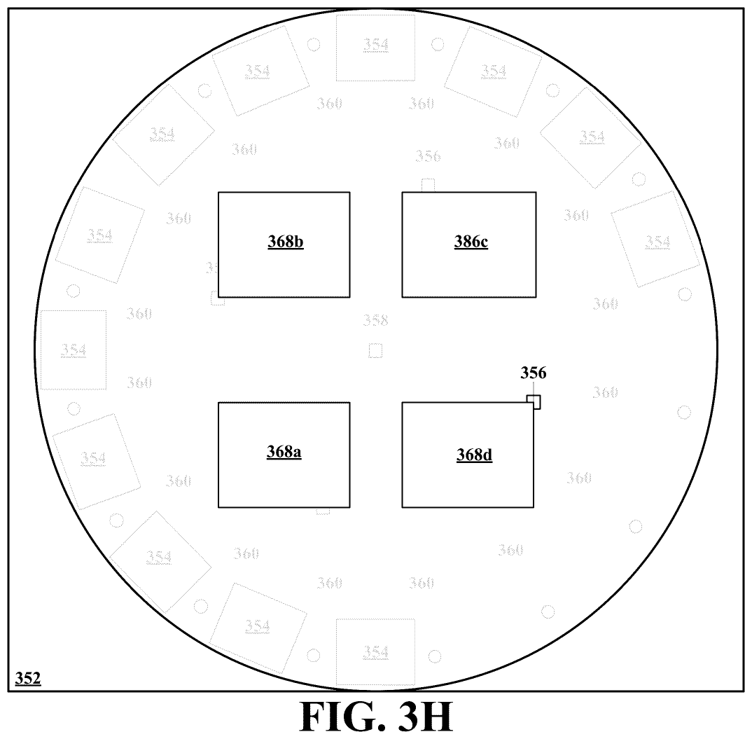

Referring now to FIG. 3A, an embodiment of a facility, generally 300, shown to include a circular room 302 including a plurality of workstations 320 configured in a circular pattern 304 with the circular room 202.

Each of the workstations 320 includes a computer 322 having a display device 324, a keyboard 326, and a mouse 328. The computer 322 may also include other input and output devices such as, voice recognition devices, joy sticks, eye tracking devices, cameras, head tracking devices, gloves, speakers, tactile device, other user discernible output device and any other input or output device, memory, a processing unit, an operating system or structure, communication hardware and software, or other features and/or devices.

The room 302 also includes a 360 degree image acquisition subsystem 306 including a degree cameras 0-16, wherein at least one of the cameras is 360 cameras or one or more the cameras are directional cameras, i.e., cameras designed to capture images within the viewing field of the directional cameras.

Referring now to FIG. 3B, an embodiment of an interactive environment of the facility, generally 350, generated from facility data captured by the 360 degree image acquisition system 112 of FIG. 3A. The interactive environment 450 comprises a combined image sequence from the image acquisition system 306, of course, the capture image sequence would also capture people entering, leaving, walking around, and working at workstations 320. While human activity is not of particular relevance here except for the work performed on the workstations 320, the apparatuses/systems may be used to identify the people and track the people for other uses.

The interactive environment 350 is displayed on a display window 352 of the display device 324. The window 352 includes workstation activation objects 354 associated with each workstation 320. The window 352 also includes sector group workstation activation objects 356, and an all workstation activation object 358. A user may activate one, some, or all of the activation objects using motion, gesture, and/or hard selection protocols. The window 352 also includes a plurality of information hot spot activation objects 360, which may also be activated using motion, gesture, and/or hard selection protocols. Of course, a 360 degree image capturing subsystem 306 may be associated with any facility, real world environment, and/or computer generated (CG) environment including only virtual (imaginary items) CG items, real world CG items, or mixture of virtual (imaginary items) CG items, real world CG items.

### Selection of an All Workstation Activation Object

Referring now to FIGS. 3C-E, an illustration of a motion-based selection of an all workstation activation object.

Looking at FIG. 3C, the apparatuses/systems detects motion in a northwest direction resulting in all activation objects possible of being selected becoming highlighted in light grey including the all workstation activation object 358 and all of the workstation activation objects 354, individual workstation activation objects 354a and 345b, and a hot spot a activation object 360a.

Looking at FIG. 3D, the apparatus/system detects further motion resulting in the all workstation activation object 358 becoming darkened and enlarged and all of the workstation activation objects 354 becoming darkened and in selecting the all workstation activation object 358, because the further motion contacts the all workstation activation object 358, contact an active zone surrounding (not shown) the all workstation activation object 358, or predicting the selection of the all workstation activation object 358 to a certainty greater than 50%. The selection may also be confirmed by the apparatus/system based on a secondary input such as voice, touch on a separate tactile device, eye gaze, head node, or other confirmatory detected input.

Looking at FIG. 3E, once the selection is made and/or made and confirmed, all of the workstation activation objects 354 become active as viewable windows 368 within the window 352. The viewable windows 368 stream the information and data coming from the display devices 324 of the workstations 320 of the facility 300 associated with all of the workstation activation objects 354. Additionally, all non-selected objects are faded to a light grey, but may also be faded out completely.

### Selection of a Group Workstation Activation Object

Referring now to FIGS. 3F-H, an illustration of a motion-based selection of a group activation object.

Looking at FIG. 3F, the apparatuses/systems detects motion in a southeast direction resulting in all activation objects possible of being selected becoming highlighted in light grey including one group workstation activation object 356a, one individual workstation activation object 154c, and one hot spot object 360a.

Looking at FIG. 3G, the apparatus/system detects further motion, which enters the group activation object 356a causing the group activation object 356a being further darkened and enlarged and the four associated workstation activation objects 354a-d being further darkened and resulting in the selection of the group activation object 356a. Of course, the selection may also be confirmed by the apparatus/system based on a secondary input such as voice, touch on a separate tactile device, eye gaze, head node, or other confirmatory detected input.

Looking at FIG. 3H, once the selection is made and/or made and confirmed, the workstation activation objects 354a-d become active as viewable windows 368a-d within the window 352. The viewable windows 368a-d stream the information and data coming from the display devices 324 of the workstations 320 of the facility 300 associated with all of the workstation activation objects 354a-d. Additionally, all non-selected objects are faded to a light grey, but may also be faded out completely.

### Embodiments of the Disclosure

Embodiment 1. An apparatus comprising:
an electronic device including one or more processing units, one or more memory units, one or more storage devices, one or more input devices, one or more output devices, an operating system or structure, software and configuration-based protocols and/or elements, communication software and hardware, and routines for implementing the apparatus; and one or more 360-image acquisition assemblies located in one or more rooms of a facility; the apparatus configured to:
   receive 360 image data from the one or more 360-image acquisition assemblies,
   for each of the one or more rooms, create a 360 environment corresponding to each one or more rooms including selectable activation objects associated with all physical items in each of the one or more rooms,
   interact with each of the one or more 360 environments and the selectable activation objects corresponding to the physical items in the one or more rooms,
   modify each of the one or more 360 environments and the selectable activation objects producing one or more modified 360 environments, and
   update the one or more 360 environments with the one or more modified 360 environments.

Embodiment 2. The apparatus of Embodiment 1, wherein each of the one or more 360 environments is overlaid on their corresponding rooms.

Embodiment 3. The apparatus of Embodiments 1 or 2, wherein the selectable activation objects include: (a) physical item selectable activation objects corresponding to the physical items in the one or more rooms, (b) visual output selectable activation objects corresponding to all devices in the one or more rooms that produce visual output data, and (c) informational hot spot activation objects comprising information and data associated with the one or more rooms and/or physical items therein.

Embodiment 4. The apparatus of any of the previous Embodiments, wherein, for the interaction, the apparatus is further configured to:
select one or more activation objects within the one or more 360 environments, and
observe and/or review data and/or information observable on or associated with the one or more selected activation objects.

Embodiment 5. The apparatus of any of the previous Embodiments, wherein, for the modification, the apparatus is further configured to:
select one or more activation objects within the one or more 360 environments,
observing and/or reviewing data and/or information observable on or associated with the one or more selected activation objects, and
modify one or more activation objects and/or one or more of the 360 environments producing one or more modified 360 environments.

Embodiment 6. The apparatus of any of the previous Embodiments, wherein, for the updating, the apparatus is further configured to:
replace the one or more one or more 360 environments with the one or more modified 360 environments.

Embodiment 7. The apparatus of any of the previous Embodiments, wherein the apparatus is further configured to:
after each selection, receive input from a separate input device to confirm each selection.

Embodiment 8. The apparatus of Embodiment 7, wherein each confirmatory input comprises voice, touch on a separate tactile device, eye gaze, head node, or other confirmatory input.

Embodiment 9. The apparatus of any of the previous Embodiments, wherein each selection occurs using hard selection protocols, motion based protocols without hard selection protocols, or any combination thereof.

Embodiment 10. The apparatus of any of the previous Embodiments, wherein the image data comprise real-time or near real-time continuous image data, semi-continuous image data, intermittent image data, on command image data, and/or any combination thereof.

Embodiment 11. The apparatus of any of the previous Embodiments, wherein the facility include a commercial facility, a residential facility, governmental facility, a military facility, a medical facility, an institution of higher education, and/or any other facility amenable to be imaged using a 360-image acquisition assembly.

Embodiment 12. The apparatus of Embodiment 11, wherein the commercial facility includes a wholesale facility, a retail facility, a manufacturing facility, a mining facility, an oil and/or gas refining facility, a chemical production facility, a recycling facilities, or any other commercial facility.

Embodiment 13. The apparatus of Embodiment 11, wherein the residential facility includes an apartment complex, a planned residential community, and/or any other residential facility.

Embodiment 14. The apparatus of Embodiment 11, wherein the medical facilities includes a hospital facility, a medical clinic facility, a nursing facility, a senior facilities, or any other medical facility.

Embodiment 15. The apparatus of Embodiment 11, wherein the institution of higher education includes a university, a college, a community college, a vocational training institution, or any other educational facility.

Embodiment 16. The apparatus of Embodiments 1-15, wherein the one or more of the selectable activation objects correspond to live feed coming from a visual output device.

Embodiment 17. The apparatus of Embodiments 1-16, wherein the 360 image acquisition subsystem include one or more 360 cameras, one or more directional cameras, and/or any combination thereof.

Embodiment 18. A system comprising:
an electronic device including one or more processing units, one or more memory units, one or more storage devices, one or more input devices, one or more output devices, an operating system or structure, software and configuration-based protocols and/or elements, communication software and hardware, and routines for implementing the system; and
a 360-image acquisition subsystem located in the one or more rooms of a facility, the system configured to:
   receive 360 image data from the one or more 360-image acquisition subsystems,
   for each of the one or more rooms, create a 360 environment corresponding to each one or more rooms including selectable activation objects associated with all physical items in each of the one or more rooms,
   interact with each of the one or more 360 environments and the selectable activation objects corresponding to the physical items in the one or more rooms,
   modify each of the one or more 360 environments and the selectable activation objects producing one or more modified 360 environments, and
   update the one or more 360 environments with the one or more modified 360 environments.

Embodiment 19. The system of Embodiment 18, wherein each of the one or more 360 environments is overlaid on their corresponding rooms.

Embodiment 20. The system of Embodiments 18-19, wherein the selectable activation objects include: (a) physical item selectable activation objects corresponding to the physical items in the one or more rooms, (b) visual output selectable activation objects corresponding to all devices in the one or more rooms that produce visual output data, and (c) informational hot spot activation objects comprising information and data associated with the one or more rooms and/or physical items therein.

Embodiment 21. The system of Embodiments 18-20, wherein, for the interaction, the system is further configured to:
select one or more activation objects within the one or more 360 environments, and
observe and/or review data and/or information observable on or associated with the one or more selected activation objects.

Embodiment 22. The system of Embodiments 18-21, wherein, for the modification, the system is further configured to:
select one or more activation objects within the one or more 360 environments,
observing and/or reviewing data and/or information observable on or associated with the one or more selected activation objects, and
modify one or more activation objects and/or one or more of the 360 environments producing one or more modified 360 environments.

Embodiment 23. The system of Embodiments 18-22, wherein, for the updating, the system is further configured to:
replace the one or more one or more 360 environments with the one or more modified 360 environments.

Embodiment 24. The system of Embodiments 18-23, wherein the apparatus is further configured to:
after each selection, receive input from a separate input device to confirm each selection.

Embodiment 25. The system of Embodiment 24, wherein each confirmatory input comprises voice, touch on a separate tactile device, eye gaze, head node, or other confirmatory input.

Embodiment 26. The apparatus of Embodiments18-25, wherein each selection occurs using hard selection protocols, motion based protocols without hard selection protocols, or any combination thereof.

Embodiment 27. The system of Embodiments 18-26, wherein the image data comprise real-time or near real-time continuous image data, semi-continuous image data, intermittent image data, on command image data, and/or any combination thereof.

Embodiment 28. The system of Embodiments 18-27, wherein the facility include a commercial facility, a residential facility, governmental facility, a military facility, a medical facility, an institution of higher education, and/or any other facility amenable to be imaged using a 360-image acquisition subsystem.

Embodiment 29. The system of Embodiment 28, wherein the commercial facility includes a wholesale facility, a retail facility, a manufacturing facility, a mining facility, an oil and/or gas refining facility, a chemical production facility, a recycling facilities, or any other commercial facility.

Embodiment 30. The system of Embodiment 28, wherein the residential facility includes an apartment complex, a planned residential community, and/or any other residential facility.

Embodiment 31. The system of Embodiment 28, wherein the medical facilities includes a hospital facility, a medical clinic facility, a nursing facility, a senior facilities, or any other medical facility.

Embodiment 32. The system of Embodiment 28, wherein the institution of higher education includes a university, a college, a community college, a vocational training institution, or any other educational facility.

Embodiment 33. The system of Embodiments 18-32, wherein the 360 image acquisition subsystem include one or more 360 cameras, one or more directional cameras, and/or any combination thereof.

Embodiment 34. The system of Embodiment 18-33, wherein the one or more of the selectable activation objects correspond to live feed coming from a visual output device.

Embodiment 35. An interface, implemented on an electronic device including one or more processing units, one or more memory units, one or more storage devices, one or more input devices, one or more output devices, an operating system or structure, software and configuration-based protocols and/or elements, communication software and hardware, and routines for implementing the interface, the interface comprising:
an apparatus including one or more 360-image acquisition assemblies located in one or more rooms of a facility,
the interface configured to:
   receive 360 image data from the one or more 360-image acquisition subsystems,
   for each of the one or more rooms, create a 360 environment corresponding to each one or more rooms including selectable activation objects associated with all physical items in each of the one or more rooms,
   interact with each of the one or more 360 environments and the selectable activation objects corresponding to the physical items in the one or more rooms,
   modify each of the one or more 360 environments and the selectable activation objects producing one or more modified 360 environments, and
   update the one or more 360 environments with the one or more modified 360 environments.

Embodiment 36. The interface of Embodiment 35, wherein each of the one or more 360 environments is overlaid on their corresponding rooms.

Embodiment 37. The interface of Embodiments 35-36, wherein the selectable activation objects include: (a) physical item selectable activation objects corresponding to the physical items in the one or more rooms, (b) visual output selectable activation objects corresponding to all devices in the one or more rooms that produce visual output data, and (c) informational hot spot activation objects comprising information and data associated with the one or more rooms and/or physical items therein.

Embodiment 38. The interface of Embodiments 35-37, wherein, for the interaction, the interface is further configured to:
select one or more activation objects within the one or more 360 environments, and
observe and/or review data and/or information observable on or associated with the one or more selected activation objects.

Embodiment 39. The interface of Embodiments 35-38, wherein, for the modification, the interface is further configured to:
select one or more activation objects within the one or more 360 environments,
observing and/or reviewing data and/or information observable on or associated with the one or more selected activation objects, and
modify one or more activation objects and/or one or more of the 360 environments producing one or more modified 360 environments.

Embodiment 40. The interface of Embodiments 35-39, wherein, for the updating, the interface is further configured to:
replace the one or more one or more 360 environments with the one or more modified 360 environments.

Embodiment 41. The interface of Embodiments 35-40, wherein the interface is further configured to:
after each selection, receive input from a separate input device to confirm each selection.

Embodiment 42. The interface of Embodiment 41, wherein each confirmatory input comprises voice, touch on a separate tactile device, eye gaze, head node, or other confirmatory input.

Embodiment 43. The interface of Embodiments 35-42, wherein each selection occurs using hard selection protocols, motion based protocols without hard selection protocols, or any combination thereof.

Embodiment 44. The interface of Embodiments 35-43, wherein the image data comprise real-time or near real-time continuous image data, semi-continuous image data, intermittent image data, on command image data, and/or any combination thereof.

Embodiment 45. The interface of Embodiments 35-44, wherein the facility include a commercial facility, a residential facility, governmental facility, a military facility, a medical facility, an institution of higher education, and/or any other facility amenable to be imaged using a 360-image acquisition subsystem.

Embodiment 46. The interface of Embodiment 45, wherein the commercial facility includes a wholesale facility, a retail facility, a manufacturing facility, a mining facility, an oil and/or gas refining facility, a chemical production facility, a recycling facilities, or any other commercial facility.

Embodiment 47. The interface of Embodiment 45, wherein the residential facility includes an apartment complex, a planned residential community, and/or any other residential facility.

Embodiment 48. The system of Embodiment 45, wherein the medical facilities includes a hospital facility, a medical clinic facility, a nursing facility, a senior facilities, or any other medical facility.

Embodiment 49. The interface of Embodiment 45, wherein the institution of higher education includes a university, a college, a community college, a vocational training institution, or any other educational facility.

Embodiment 50. The interface of Embodiments 35-49, wherein the 360 image acquisition subsystem include one or more 360 cameras, one or more directional cameras, and/or any combination thereof.

Embodiment 51. The interface of Embodiment 35-50, wherein the one or more of the selectable activation objects correspond to live feed coming from a visual output device.

Embodiment 52. A method, implemented on an electronic device including one or more processing units, one or more memory units, one or more storage devices, one or more input devices, one or more output devices, an operating system or structure, software and configuration-based protocols and/or elements, communication software and hardware, and routines for implementing the method, the method comprising:
receiving 360 image data from the one or more 360-image acquisition subsystems,
for each of the one or more rooms, creating a 360 environment corresponding to each one or more rooms including selectable activation objects associated with all physical items in each of the one or more rooms,
interacting with each of the one or more 360 environments and the selectable activation objects corresponding to the physical items in the one or more rooms,
modifying each of the one or more 360 environments and the selectable activation objects producing one or more modified 360 environments, and
updating the one or more 360 environments with the one or more modified 360 environments.

Embodiment 53. The method of Embodiment 52, wherein, in the creating step, the one or more 360 environments is overlaid on their corresponding rooms.

Embodiment 54. The method of Embodiments 52-53, wherein, in the creating step, the selectable activation objects include: (a) physical item selectable activation objects corresponding to the physical items in the one or more rooms, (b) visual output selectable activation objects corresponding to all devices in the one or more rooms that produce visual output data, and (c) informational hot spot activation objects comprising information and data associated with the one or more rooms and/or physical items therein.

Embodiment 55. The method of Embodiments 52-54, wherein the interacting comprises:
selecting one or more activation objects within the one or more 360 environments, and
observing and/or reviewing data and/or information observable on or associated with the one or more selected activation objects.

Embodiment 56. The method of Embodiments 52-55, wherein the modifying comprises:
selecting one or more activation objects within the one or more 360 environments,
observing and/or reviewing data and/or information observable on or associated with the one or more selected activation objects, and
modifying one or more activation objects and/or one or more of the 360 environments producing one or more modified 360 environments.

Embodiment 57. The method of Embodiments 52-56, wherein the updating comprises:
replacing the one or more one or more 360 environments with the one or more modified 360 environments.

Embodiment 58. The method of Embodiments 52-57, the method further comprising:
after each selection, receiving input from a separate input device to confirm each selection.

Embodiment 59. The system of Embodiment 58, wherein each confirmatory input comprises voice, touch on a separate tactile device, eye gaze, head node, or other confirmatory input.

Embodiment 60. The apparatus of Embodiments 52-59, wherein, in any of the step, each selection occurs using hard selection protocols, motion based protocols without hard selection protocols, or any combination thereof.

Embodiment 61. The system of Embodiments 52-60, wherein, in the receiving step, the image data comprise real-time or near real-time continuous image data, semi-continuous image data, intermittent image data, on command image data, and/or any combination thereof.

Embodiment 62. The system of Embodiments 52-61, wherein, in the receiving step, the facility include a commercial facility, a residential facility, governmental facility, a military facility, a medical facility, an institution of higher education, and/or any other facility amenable to be imaged using a 360-image acquisition subsystem.

Embodiment 63. The system of Embodiment 62, wherein, in the receiving step, the commercial facility includes a wholesale facility, a retail facility, a manufacturing facility, a mining facility, an oil and/or gas refining facility, a chemical production facility, a recycling facilities, or any other commercial facility.

Embodiment 64. The system of Embodiment 62, wherein, in the receiving step, the residential facility includes an apartment complex, a planned residential community, and/or any other residential facility.

Embodiment 65. The system of Embodiment 62, wherein, in the receiving step, the medical facilities includes a hospital facility, a medical clinic facility, a nursing facility, a senior facilities, or any other medical facility.

Embodiment 66. The system of Embodiment 62, wherein, in the receiving step, the institution of higher education includes a university, a college, a community college, a vocational training institution, or any other educational facility.

Embodiment 67. The system of Embodiments 52-66, wherein, in the receiving step, the 360 image acquisition subsystem include one or more 360 cameras, one or more directional cameras, and/or any combination thereof.

Embodiment 68. The system of Embodiment 52-67, wherein, in the receiving step, the one or more of the selectable activation objects correspond to live feed coming from a visual output device.

### Closing Paragraph of the Disclosure

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

1. An apparatus comprising:
an electronic device including one or more processing units, one or more memory units, one or more storage devices, one or more input devices, one or more output devices, an operating system or structure, software and configuration-based protocols and/or elements, communication software and hardware, and routines for implementing the apparatus; and
one or more 360-image acquisition assemblies located in one or more rooms of a facility, the apparatus configured to:
receive 360 image data from the one or more 360-image acquisition assemblies,
for each of the one or more rooms, create a 360 environment corresponding to each one or more rooms including selectable activation objects associated with all physical items in each of the one or more rooms,
interact with each of the one or more 360 environments and the selectable activation objects corresponding to the physical items in the one or more rooms,
modify each of the one or more 360 environments and the selectable activation objects producing one or more modified 360 environments, and
update the one or more 360 environments with the one or more modified 360 environments.

2. The apparatus of claim 1, wherein each of the one or more 360 environments is overlaid on their corresponding rooms.

3. The apparatus of claim 1, wherein the selectable activation objects include: (a) physical item selectable activation objects corresponding to the physical items in the one or more rooms, (b) visual output selectable activation objects corresponding to all devices in the one or more rooms that produce visual output data, and (c) informational hot spot activation objects comprising information and data associated with the one or more rooms and/or physical items therein.

4. The apparatus of claim 1, wherein, for the interaction, the apparatus is further configured to:
select one or more activation objects within the one or more 360 environments, and observe and/or review data and/or information observable on or associated with the one or more selected activation objects.

5. The apparatus of claim 4, wherein each selection occurs using hard selection protocols, motion based protocols without hard selection protocols, or any combination thereof.

6. The apparatus of claim 1, wherein, for the modification, the apparatus is further configured to:
select one or more activation objects within the one or more 360 environments,
observe and/or review data and/or information observable on or associated with the one or more selected activation objects, and
modify one or more activation objects and/or one or more of the 360 environments producing one or more modified 360 environments.

7. The apparatus of claim 6, wherein each selection occurs using hard selection protocols, motion based protocols without hard selection protocols, or any combination thereof.

8. The apparatus of claim 1, wherein, for the updating, the apparatus is further configured to:
replace the one or more one or more 360 environments with the one or more modified 360 environments.

9. The apparatus of claim 1, wherein the apparatus is further configured to:
after each selection, receive input from a separate input device to confirm each selection.

10. The apparatus of claim 9, wherein each confirmatory input comprises voice, touch on a separate tactile device, eye gaze, head node, or other confirmatory input.

11. The apparatus of claim 1, wherein the image data comprise real-time or near real-time continuous image data, semi-continuous image data, intermittent image data, on command image data, and/or any combination thereof.

12. The apparatus of claim 1, wherein the facility include a commercial facility, a residential facility, governmental facility, a military facility, a medical facility, an institution of higher education, and/or any other facility amenable to be imaged using a 360-image acquisition assembly.

13. The apparatus of claim 12, wherein the commercial facility includes a wholesale facility, a retail facility, a manufacturing facility, a mining facility, an oil and/or gas refining facility, a chemical production facility, a recycling facility, or any other commercial facility.

14. The apparatus of claim 12, wherein the residential facility includes an apartment complex, a planned residential community, and/or any other residential facility.

15. The apparatus of claim 12, wherein the medical facilities includes a hospital facility, a medical clinic facility, a nursing facility, a senior facilities, or any other medical facility.

16. The apparatus of claim 12, wherein the institution of higher education includes a university, a college, a community college, a vocational training institution, or any other educational facility.

17. The apparatus of claim 1, wherein the one or more of the selectable activation objects correspond to live feed coming from a visual output device.

18. The apparatus of claim 1, wherein the 360 image acquisition assemblies include one or more 360 cameras, one or more directional cameras, and/or any combination thereof.

19. An interface, implemented on an electronic device including one or more processing units, one or more memory units, one or more storage devices, one or more input devices, one or more output devices, an operating system or structure, software and configuration-based protocols and/or elements, communication software and hardware, and routines for implementing the interface, the interface comprising:
an apparatus including one or more 360-image acquisition assemblies located in one or more rooms of a facility,
the interface configured to:
receive 360 image data from the one or more 360-image acquisition subsystems,
for each of the one or more rooms, create a 360 environment corresponding to each one or more rooms including selectable activation objects associated with all physical items in each of the one or more rooms,
interact with each of the one or more 360 environments and the selectable activation objects corresponding to the physical items in the one or more rooms,
modify each of the one or more 360 environments and the selectable activation objects producing one or more modified 360 environments, and
update the one or more 360 environments with the one or more modified 360 environments.

20-37. (canceled)

38. A method, implemented on an electronic device including one or more processing units, one or more memory units, one or more storage devices, one or more input devices, one or more output devices, an operating system or structure, software and configuration-based protocols and/or elements, communication software and hardware, and routines for implementing the method, the method comprising:
receiving 360 image data from the one or more 360-image acquisition subsystems,
for each of the one or more rooms, creating a 360 environment corresponding to each one or more rooms including selectable activation objects associated with all physical items in each of the one or more rooms,
interacting with each of the one or more 360 environments and the selectable activation objects corresponding to the physical items in the one or more rooms,
modifying each of the one or more 360 environments and the selectable activation objects producing one or more modified 360 environments, and
updating the one or more 360 environments with the one or more modified 360 environments.

39-55. (canceled)
